(19) United States
(12) Patent Application Publication
(10) Pub. No.: US 2013/0275187 A1
(43) Pub. Date: Oct. 17, 2013

(54) WORK MEASUREMENT TOOLKIT

(71) Applicant: Work Measurement Analyteks, LLC, Chattanooga, TN (US)

(72) Inventor: Pranav Patel, Chattanooga, TN (US)

(21) Appl. No.: 13/841,063

(22) Filed: Mar. 15, 2013

Related U.S. Application Data
(60) Provisional application No. 61/612,784, filed on Mar. 19, 2012.

(51) Int. Cl. G06Q 10/06

(52) U.S. Cl. CPC G06Q 10/06398
USPC 705/7.42

(57) ABSTRACT

A customizable work measurement tool that includes a data gathering tools to facilitate work sampling. A setup process generates customized data tables that are synced to a mobile computing device. The mobile computing device utilizes the data tables to generate a user interface presenting predefined lists and parameters based on an interactive decision matrix. Activity and parameter selection may be prompted by sensor readings received by the mobile computing device that identify locations, workers, or assets. Users may be provided data collection routes, data collection instructions, prompts, and tools for acquiring work observations including comments on work activities. The collected work observations may be analyzed for reporting, data mining, and historical benchmark comparisons. The storage of data categorizes each data point as direct work, indirect work, barriers to work, or a delay thereby providing in-depth analysis and reporting capabilities.

### CLAIM OF PRIORITY

This patent application claims the benefit of priority of Pranav Patel U.S. Provisional Patent Application Ser. No. 61/612,784, titled “WORK MEASUREMENT TOOLKIT,” filed on Mar. 19, 2012, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012, Work Measurement Analyteks, LLC. All Rights Reserved.

### BACKGROUND

Work sampling is a technique for studying an activity by making randomly spaced observations of the activity. The observations may be used to estimate the percentage of time devoted to a given task. Work sampling can be particularly useful for studying work in areas involving no repetitive work and where a work unit can be identified with staff-hour input. Examples of such areas include clerical work, maintenance, warehousing, rebuild, repair, or other labor indirect operations. Work sampling can be used for development of engineered time standards, determination of delay allowances, utilization studies of staff and equipment, work distribution studies, performance studies, and general information gathering.

Work sampling or measurement typically focuses on measuring the performance of individual workers that are assigned a task. For example, U.S. Pat. No. 6,304,851 to Kmack et al. discloses data collection methods, apparatuses and computer program products related to time and motion studies. U.S. Pat. No. 6,968,312 to Jordan et al. discloses a system and method for measuring and managing performance in an information technology organization. U.S. Pat. No. 7,596,507 to Gibson discloses methods, systems, and storage mediums for managing accelerated performance.

### Overview

Work sampling may be used to estimate how much worker or equipment time is distributed over two or more types of activity. Work sampling may be desired when it is not convenient, not possible, or too expensive to obtain this information from records or automatic recording devices. Work sampling provides a mechanism to measure work that was not economical to measure with a time study or predetermined time systems. Work sampling may compliment rather than antiquate other work measurement techniques.

An example procedure for conducting a work sampling study may include: determining the purpose of the study, obtaining supervisory approval, preparing for the study, designing the study, conducting the study, summarizing and analyzing the collected data, and preparing a report. Work sampling may assist in determining objectives by providing a picture of the present situation so that specific goals may be selected to improve the situation. Work sampling may be utilized to determine work assignments and distribution of work, particularly for skilled or short-supply personnel, such as, nurses, engineers, teachers, doctors, and work supervisors. Work sampling can provide a factual basis for determining allowances for engineered standards. Additionally, establishing standards based on work sampling may be valuable in areas where other techniques are not practical.

Work sampling may allow a business or supervisor to determine improvements to optimize equipment utilization scheduling. By collecting and analyzing facts upon which decisions can be made concerning need for capital expenditures, revision of schedules, and the like, work sampling can assist in determining areas of concentration for methods study, or indicates where most time is being spent, and where bottlenecks exist in a process or procedure. Work sampling may provide a picture of the nature of cyclic variations in a work environment and their effect. A work sampling study can be extended over a long period of time and may be interrupted without effecting results.

An example data collection tool may provide a user interface allowing a human data collector (e.g., a user) to quickly and efficiently gather accurate work site performance data. The data collection tool may provide a user-friendly automated work sampling interface that may be customized for any industry type or worker productivity measurement. Work site performance data may include detailed information in at least four general categories: time measurements, human activities, resource information, and location information. Time is one measure of any work performance. Human activities can include the type and number of human workers engaged in specific tasks, worker experience, title, skill level, union membership status, reasons for work stoppage (e.g., breaks, travel, accidents, etc.), and any known measure of human performance. Resource information can include equipment status, resource availability, tool availability, tool or asset breakage, and the like. Location information can include work site conditions, business unit information, geographic location, environmental conditions (e.g., indoors/outdoors, clean-room, weather, climate, etc.), distances between resources or work activities, travel times, or industry information. Together a combination of any of these elements can provide useful information to evaluate, compare, and potentially improve on work performance.

An example embodiment of a work measurement system may include a detailed setup tool for consistent deployment of the worker productivity initiative company wide. An example setup tool may allow the company to setup accurate goals, policies and procedures, and deliverables for all sites and workers within their company. In an example, categories such as shift performance, personal fatigue delay allowances, and work rule allowances, may be checked and audited at multiple stages, for example, at the corporate, site, and event level stages.

An example work measurement system may provide an analysis of each location so that a clear understanding of the desired outcomes, required policies and procedures to improve worker performance may be developed. At multiple levels of detail, users may customize and modify data based upon their physical facility environment and criterion, still allowing corporate and site management to do gap analysis for benchmarking purposes and facility improvement for better quality of work life and ease of work package execution. The example work measurement system may provide detailed work sampling tools with customizable sub activities in order to provide measurement-specific data mapping and root cause analysis.

A location may include the specific site where an industry operates. A site may be divided into several units, or independently functioning areas of the site. A user may specify how many units a company operates per site. Assets may include specific tangible products, brands, and equipment a company uses to produce value at the Site. A craft may include a category that describes a business' product, for example, agriculture, manufacturing, utilities, wholesale trade, or other service or business activities.

An event may include a scheduled process undertaken at a location, usually with a specific focus or expected outcome. Events may be categorized by a number of event types specific to an industry or work activity, or customized by a user for an individual organization. Event types available for scheduling at a site may include, for example: planned outages (PO) such as scheduled downtime of a unit, typically with a goal of maintaining the unit's individual assets to ensure uptime when the unit functions fully; routine maintenance (RM) that occurs while a unit is still in operation, for example, to ensure clean, safe, and efficient procedures; operations (OP) that include the processes, functions, monitors, and controls of a unit; capital projects (CP), which may incur relatively large sums to acquire, develop, improve, and/or maintain capital assets and cover costs of operation at a unit; and special projects (SP) that may include income-earning operations outside a company's normal mode of operation; and forced outages (FO) that may include the time during which a unit is scheduled to operate but is unable to do so because of breakdowns or other unforeseen failures.

In an example embodiment, a work measurement system may include an interface where users may input work-sampling measurements specific with the parameters that are processed through a decision matrix. A decision matrix may be provided to simplify the actual data collection process, and make the process easier and more intuitive for the data collection user. The work measurement system may include sensors that receive data that may be used to validate user entered work-sampling measurements.

In an example embodiment, a work measurement system may include a system intelligence module that evaluates the accuracy and confidence levels of readings and notifies the data collector once desired collection goal or rate is attained. The system intelligence module calculates collection performance based upon preset confidence level and study validation parameters for the data collection project. The accuracy of the data can directly impact the representativeness of the study. Through precise monitoring of the measuring process, for example, the number of observations, the coverage of work cycle, and the relative size of the sample with regard to the population; the validity of the data collection project can be accurately measured.

In an example embodiment, a historical database, can utilize statistically computed algorithms to predict any anomalies, and notifies users of upper and lower control limits for desired outputs, targets and goals, as well as flag human errors or bias in the data collection process. For example, an individual data collector may be biased towards or against a particular location, craft or task. Individual discrepancies between the observations of multiple data collectors may be excluded due to an observed bias regardless of whether an individual data collector is conscious of the bias. Users may receive email alerts or other notifications if work measurement samples indicate encroachment upon goals or error conditions.

In an example embodiment of a work management data collection system, users may link real-time comments, suggestions, and images directly to work sampling data point collection readings for sophisticated evaluation of the study and root cause analysis during future data mining.

In an example embodiment, a work measurement system may include a mechanism to record the local and appropriate time zone of a site's physical location, and may override settings on a mobile computing device's default time to ensure that accurate date and time stamp for the field data collection related to site. Accurate measurement and consistent recording of data can improve data collection validity and reduce the cases where errors or data collector bias can bias the reported activity.

This overview is intended to provide an overview of subject matter of the present patent application. It is not intended to provide an exclusive or exhaustive explanation of the invention. The detailed description is included to provide further information about the present patent application.

### BRIEF DESCRIPTION OF DRAWINGS

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 illustrates an example work measurement scenario, according to an embodiment.

FIG. 2 depicts a flow diagram illustrating example information that may be utilized for work sampling, according to an embodiment.

FIG. 3 depicts a flow diagram illustrating an example work sampling process, according to an embodiment.

FIG. 4A depicts a block diagram illustrating an example of a user interface hierarchy for a work sampling tool kit, according to an embodiment.

FIG. 4B depicts a block diagram illustrating an example of a user interface hierarchy for a work sampling tool kit, according to an embodiment.

FIG. 5 depicts a block diagram illustrating an example system map of a work sampling toolkit, according to an embodiment.

FIG. 6 illustrates an example user creation interface, according to an embodiment.

FIG. 7 illustrates an example registration interface, according to an embodiment.

FIG. 8 illustrates an example of entering a standardized industry and labor classification code in the example registration interface, according to an embodiment.

FIG. 9 illustrates an example resource loading interface, according to an embodiment.

FIG. 10 illustrates an example of a fleet goal interface, according to an embodiment.

FIG. 11 illustrates an example of an activity user interface, according to an embodiment.

FIG. 12 illustrates an example of a site setup screen, according to an embodiment.

FIG. 13 illustrates an example of a unit creation tab of the site setup screen depicted in FIG. 12, according to an embodiment.

FIG. 14 illustrates an example of an event interface, according to an embodiment.

FIG. 15 illustrates an example of a work force interface, according to an embodiment.

FIG. 16 illustrates an example of an interface to track personal fatigue and delay (PFD), according to an embodiment.

FIG. 17 illustrates an example of a shift interface, according to an embodiment.

FIG. 18 illustrates an example of a mobile-device application interface, according to an embodiment.

FIG. 19 illustrates an example of a data collection interface of a mobile device application, according to an embodiment.

FIG. 20 illustrates a further example of the data collection interface depicted in FIG. 19, according to an embodiment.

FIG. 21 illustrates an example of a data collection interface, according to an embodiment.

FIG. 22 illustrates an example of a study validation calculator interface, according to an embodiment.

FIG. 23 illustrates an example of a pending data review interface, according to an embodiment.

FIG. 24 illustrates an example of a data reading comments interface, according to an embodiment.

FIG. 25 illustrates an example of a mobile data collection interface displaying historical route collection data, according to an embodiment.

FIG. 26 illustrates an example line chart report organized by contractor groups, according to an embodiment.

FIG. 27 illustrates an example report in a bar chart format, according to an embodiment.

FIG. 28 illustrates an example category report in a table format, according to an embodiment.

FIG. 29 depicts a block diagram illustrating an example directory module with a plurality of databases, according to an embodiment.

FIG. 30 depicts a block diagram illustrating an example logic module, according to an embodiment.

FIG. 31 depicts a block diagram illustrating an example schedule module, according to an embodiment.

FIG. 32 is a block diagram illustrating an example collection module, according to an embodiment.

FIG. 33 depicts a block diagram illustrating an example collection module databases, according to an embodiment.

FIG. 34 depicts a block diagrams illustrating an example of work databases, according to an embodiment.

FIG. 35 depicts a block diagram illustrating an example of permissions databases, according to an embodiment.

FIG. 36 depicts a block diagram illustrating an example directory database, according to an embodiment.

FIG. 37 depicts a block diagram illustrating an example of business databases, according to an embodiment.

FIG. 38 depicts a block diagram illustrating an example of people databases, according to an embodiment.

FIG. 39 depicts a block diagram illustrating an example of location databases, according to an embodiment.

FIG. 40 depicts a block diagram illustrating an example of work order databases, according to an embodiment.

FIG. 41 depicts a block diagram illustrating an example of study databases, according to an embodiment.

FIG. 42 depicts a block diagram illustrating an example of work sampling databases, according to an embodiment.

FIG. 43 depicts a block diagram illustrating an example of a user interface site hierarchy for a work sampling tool kit application, according to an embodiment.

FIG. 44 illustrates a block diagram of an example machine upon which any one or more of the techniques (e.g., methodologies) discussed herein may be performed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Work measurement may include the determination of the required time to perform a task content of a specified amount of work, or a work unit. Work measurement tools may produce a statement of a time standard for performing a job and a description of the job. For example, a description of a job may include a series of actions to be performed, a list of tools or equipment necessary or useful to perform the job, a level of training or skill typically needed to complete the job, and measures of service, quality or performance.

An example work measurement tool may provide the ability for users to set productivity goals associated with each activity and category by goal: baseline, initial, and multiyear by fleet, event type, or any other measurement category.

An example work measurement tool may provide an interface to allow specified users to set their upper and lower control limits for meeting targeted goals. The system may send email notifications to users providing efficient and timely monitoring targets during the duration of a job study.

An example work measurement tool may provide an interface allowing detailed resource loading by event type and work package. Resource loading in advance of a work measurement project may provide an accurate knowledgebase establishing an organization's internal work measurement standards for benchmarking purposes.

An example work measurement tool may provide users with a capability to track personal fatigue and delay (PFD) and location-specific barrier allowances, which may allow for accurate comparisons between specific groups and crafts working at the same location. In this manner, the comparisons between actual available and unavailable production time per shift for each group or craft may be improved.

An example work measurement tool may include a mobile application that provides an interface for data collection. The mobile application may include a decision matrix to stream line and ease field data collection efforts, as well as to provide more accurate data collection and resulting analysis.

An example work measurement tool may provide users with interactive feedback prior to, during, and post work sampling data collection based on job set up calculations to ensure predetermined confidence level and study accuracy for overall study validation.

An example work measurement tool provide users with on-point field-data, the ability to enter real-time comments, suggestions, and image attachments that may be linked directly to work sampling data collection readings for sophisticated evaluation of the study and root cause analysis during data mining.

An example work measurement tool may include statistically computed algorithms to predict and prevent human error and study biases based on our system's historical database for study accuracy.

An example work measurement tool may provide standardized industry and labor classification codes defined by the regulated industry type NAICS code and O*Net database generated by the Department of Labor, which serve as cross-references for accurate data mining.

An example work measurement tool may provide a centralized place for data mining capabilities for study final results with NAICS code and sub-codes for industry specific internal, industry, and best practices benchmarking.

An example work measurement tool may provide a cross-platform system that can work on a cloud server application on any browser or any operating system and/or mobile device currently in the market regardless of location or time of use.

An example work measurement tool may include a system that stores data and distinguishes between client identifiable and non-identifiable data in order to maintain integrity and privacy of the client's information and collected data while also capitalizing on benchmarking capabilities that may be obtained from the analysis of anonymous pools of work performance.

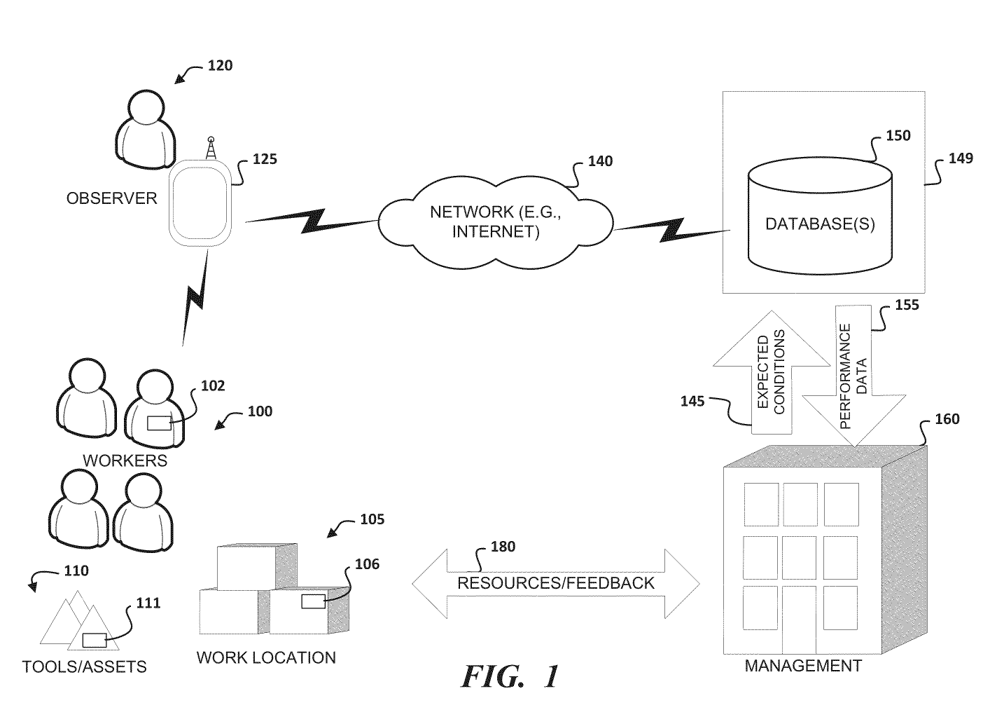

In an example scenario illustrated in FIG. 1, a plurality of workers 100 (e.g., employees, union members, etc.) at a work location 105 (e.g., job site, office, factory, farm, etc.) may utilize various tools or assets 110 to complete a task, assignment or project within a specified time frame. An observer 120 may utilize a mobile computing device 125, which is capable of communication over a network 140, to record the activities of the workers 100, the use or need for tools or assets 110, and any features, obstacles or environmental characteristics of the work location 105 that may affect the completion of the task, assignment or project. The mobile computing device 125 may include one or more sensors configured to receive location data (e.g., a GPS receiver) or to detect tags such as radio frequency identification (RFID) tags.

The plurality of workers 100 may wear an identifying badge 102 or uniform to identify their name, trade, craft, union, or other identity or association. The badge 102 may include a bar code, matrix bar code (e.g., QR code), or a RFID tag that includes a unique identifier or other identifying data. For example, a pipefitter may wear a hard-hat that includes an embedded RFID badge encoded with data that identifies the wearer as a pipefitter who is a member of a specific union that is employed by an individual contractor. The mobile computing device 125 may be configured to actively (e.g., in response to a user input) or passively (e.g., automatically) receive any data provided by badge 102. For example, when the mobile computing device 125 is within a proximity range of one or more badges 102 containing an active RFID tag the mobile computing device 125 may record the number of badges 102 at the location of the mobile computing device 125, in addition to retrieving any identifying information contained in each badge 102.

The tools or assets 110 may include an identifying tag 111, such as a bar code, matrix bar code, or RFID tag, which identifies the tool or asset. For example, a power plant may have multiple power generation units (e.g., turbines or boilers) that are each labeled with a QR code that indicates the number, location, capacity, and age of an individual power generation unit. In an example, a location with one or more elevators may have an RFID tag embedded in each elevator car indicating the location and car number of the elevator car. The mobile computing device 125 may be configured to actively (e.g., in response to a user input) or passively (e.g., automatically) receive any data provided by tag 111. For example, the mobile computing device 125 may interact with the RFID tag of an individual elevator car to obtain its precise location and to determine the amount of time spend in the elevator car when traveling between floors.

The work location 105 may include a plurality of area markers 106, such as a bar codes, matrix bar codes, or RFID tags, which are correlated to specific locations within the work location 105. For example, a factory may include an area marker 106 on each column in the factory when the columns such that a grid pattern may be formed by the area markers 106 defining a plurality of work areas within the factory. The mobile computing device 125 may be configured to actively (e.g., in response to a user input) or passively (e.g., automatically) receive any data provided by area markers 106. For example, the mobile computing device 125 may receive a signal from or detect the presence of multiple area markers 106 within the factory and triangulate an exact location of the mobile computing device 125 within the factory based on data obtained from the multiple area markers 106. In this manner a mobile computing device 125 may discover its location in the absence of a global positioning signal or other navigation aids.

The mobile computing device 125 may be initially loaded with a set of expected conditions 145 that may include data related to the work location 105, the expected number or type of workers 100 and their schedules, and any tool or asset 110 resources at the work location 105 or needed by the workers 100. The mobile computing device 125 may obtain this initial data set from a database 150 that is coupled to the network 140 and populated by a managing authority 160, consultant, observer 120, or other entity with knowledge of the task, assignment or project.

The observations of the observer 120 can be entered into the mobile computing device 125 in a format outlined by the initially loaded set of expected conditions 145, or the observer 120 may add or update data or the format for observed data collection at the mobile computing device 125 during observation activities. The entered observations of the user may be validated by the mobile computing device 125 by comparing the entered observations with sensor data received from any of badges 102, area markers 106, or identifying tags 111 that were interrogated by the mobile computing device 125 during a work observation session. Any discrepancies between the entered observations and the sensor data may be presented to the observer 120 through a user-interface of the mobile computing device 125. All collected data on the mobile computing device 125 and any post-observation updates entered by the observer 120 can be communicated through the network 140 to a server 149 that includes the database 150. The collected data in the database 150 may be utilized to generate real-time updates or reports that can be provided to management 160. A database 150 may include any collection of records stored on the server 149. For example, the database 150 may include multiple databases that each organize collected data in tables or other appropriate formats.

Work measurement observations that are recorded with the mobile computing device 125 by the observer 120 may supply quantitative information to database 150 and management 160 for programming and planning work and for scheduling the use of workers 100 and facilities at work location 105. Quantitative information provided to management 160 may allow appraising the organization and for evaluating the status of the various operations, tasks, or projects. Work Measurement data obtained from reports generated from information in database 150 may furnish refined data to management for use in controlling costs, operating efficiency, staffing requirements and productivity measurement.

Management 160 may take action to provide resources or feedback 180 to workers or supervisors at the work location 105 to avoid or mitigate work stoppages or activity bottle necks in response to receiving a notification generated at the server 149. Management 160 may use work measurement data to set schedules and program activities, determine supervisory objectives, determine operating efficiency, compare methods, determine standard costs, set labor standards, provide a basis for setting incentive wages, determine equipment and labor requirements, balance work of crews and lines, or determine the number of machines a person operates.

An example approach may involve tracking a variety of workers individually and analyzing the collected data. However, an individual worker may not accurately reflect the activities of multiple workers at a large project site. Additionally, it is desirable for an individual data collector or observer 120 to have knowledge of the type of work or tasks that the workers 100 should or could be performing in order to accurately evaluate the work being observed at a location 105. The use of a pre-programmed mobile computing device 125 may alleviate the problem of inaccurate data collection, because the observer 120 can be presented with a data collection template containing information about what expected conditions 145 should be found at a work location 105. Additionally, the observer 120 may be provided with a mechanism to accurately indicate what was observed at the work location 105 even if that information does not match the data collection template.

An example work measurement toolkit including a mobile computing device 125 configured with expected conditions 145 and a easy to use graphical user interface may provide tools and techniques to homogenize work sampling, potentially utilizing a variety of work measurement standards, while also exhausting all possibilities and keeping all recorded activities mutually exclusive so that a proper discrimination between work measurement categories can be made at the moment of observation, and later contextually processed and analyzed.

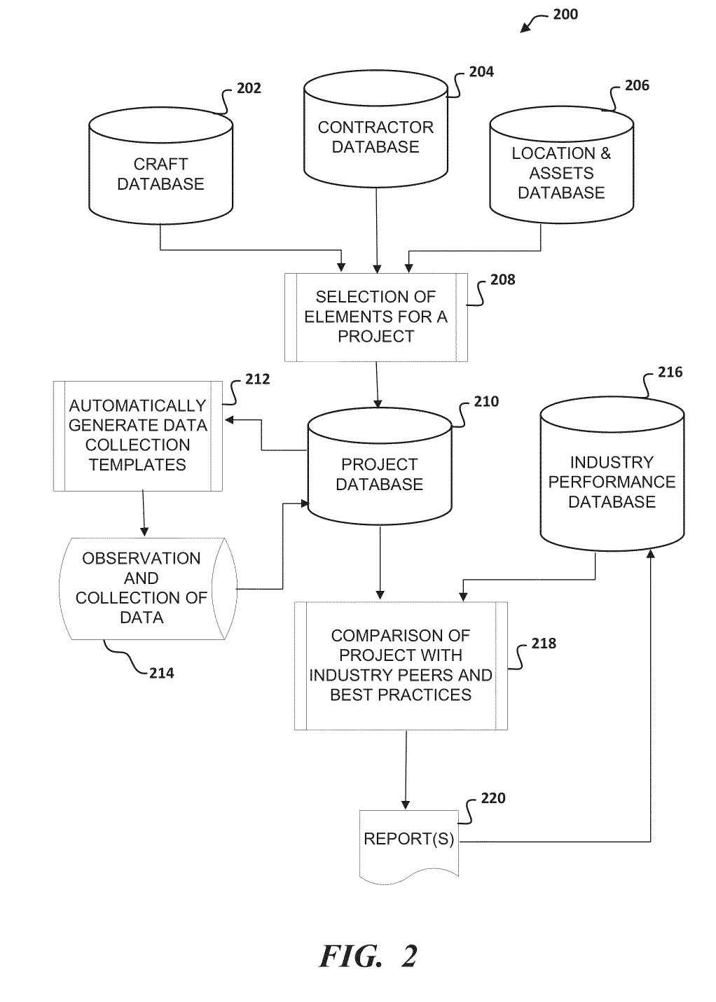

FIG. 2 depicts a flow diagram 200 illustrating example information that may be utilized for work sampling, according to an embodiment. Databases, such as a craft database 202, contractor database 204, and location and assets database 206 may include, and be utilized to provide, a plurality of elements that are desired or available for a project. Crafts, work activities, or industries may be classified according to the published U.S. Labor Department or Census Bureau's standardized North American Industry Classification System (NAICS) codes. At 208, the selected data for a project may be combined into a project database 210 that may be utilized, at 212, to generate data collection templates for use by an observing data collector 214. The observed data may be collected locally in real time on a mobile computing device and continuously or periodically transmitted to the project database 210.

An industry performance database 216 including industry performance data related to the project may be utilized to compare the observed data for the project in order to generate a comparison of the project 218 with industry peers or best practices. Reports 220 may be generated that detail the observed project as well as the comparison of any of the categories or events related to the project.

In an example, the centralized storage of collected data in a project database may be used for data validation by providing a list of crafts defined by tasks, tools and technology, knowledge, skills, abilities, work activities, work context, job zone, education, interest, work style, work values, related occupation, or any additional information associated with an individual craft. In an example, the centralized storage of collected data in a project database may be used for data aggregation. The categorization of the measurement and sampling data may be ground into four categories and provided with a color reference for ease of reporting. For example, direct (green), indirect (yellow), barriers (orange) and delay (red) categories assigned to work sampling data may be utilized for cross-industry standardization and benchmarking.

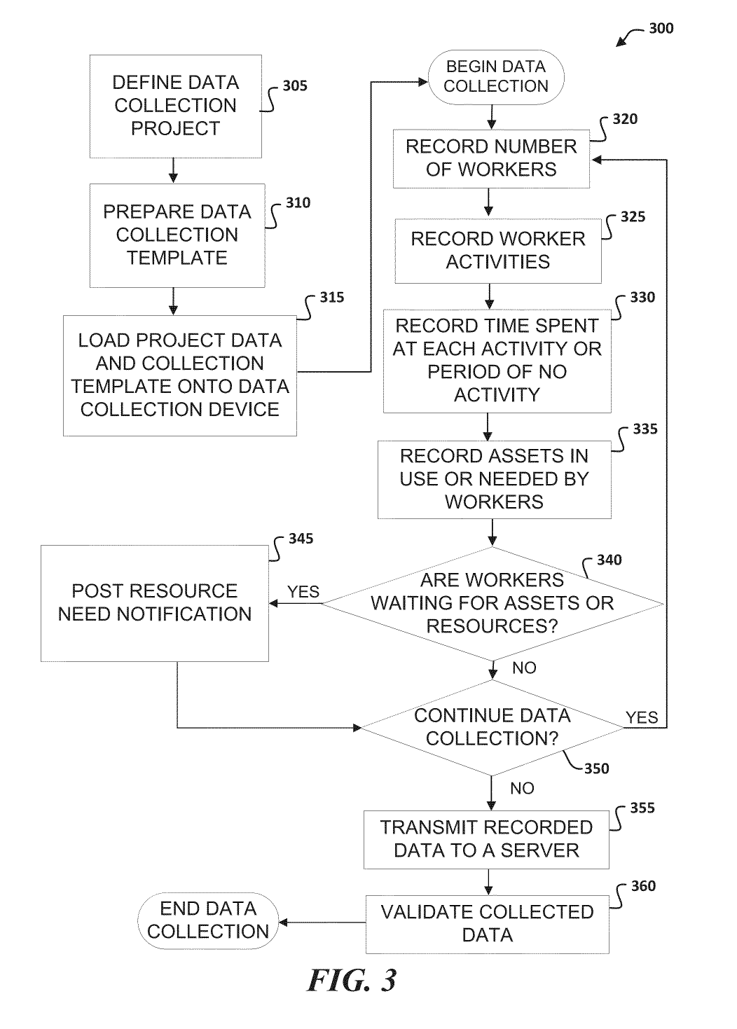

FIG. 3 depicts a flow diagram illustrating an example work sampling process 300, according to an embodiment. Although the elements in the work sampling process 300 are presented in a sequential manner, alternate ordering of elements is possible and contemplated. At 305, a user may define the data collection project and provide the system with data that is expected to be present at a work site. For example, a work measurement tool may provide a system with an interface that allows users to provide detailed setup and customizable work sampling studies that are customized for an industry type, sub industry type, craft type, job type, event type, available assets, shift type, personal fatigue and delay allowances, tagged data comment types, action items, and recommendations associated with data type, and other factors to facilitate accurate data collection and to provide input to a data mining analysis to produce work measurements reports that may lead to improvements in work performance.

At 310, a data collection template may be manually or automatically generated for use in collecting data for the project. The data collection template may include both anticipated worker activities, and resource or asset availability. During the setup process, a user may create a corporate profile and define specific data tables such as location, sites, unit assets, events, user groups, activities, and sub-activities. A list of possible values and activities may be defined for each parameter during setup. The setup process may be implemented with menu-driven/fill in the blank user interfaces that can be used by a non-programmer to configure and customize the information. At 315, the data collection template may be loaded into a mobile collection device, such as a handheld table computer, for use in recording the work sampling data for the project.

Work sampling may include, at 320, recording the number of workers present at any location on a work site. Recording the number of workers at the location may be facilitated by a sensor in the mobile collection device configured to interact with a badge worn by each worker that indicates their identity, occupation (e.g., craft, trade, or role), and other relevant work data. An observer may, at (325, 330, 335), in any order, record the worker activities, the type of worker performing the activity, the time spent on each activity or periods of inactivity, and any assets or tools in use or needed by the observed workers. The location of the workers may be entered by an observer, or determined by the mobile collection device through the use of a GPS receiver or through the use of one or more sensors configured to receive an indication from one or more area markers in the location.

If, at 340, the observer records data that indicates workers are waiting for access to a site location, or specific assets or resources, a work measurement system may, at 345, post a resource need notification to a central database through a wireless communication network. A server coupled to the central database may process the notification and generate one or more messages or alerts to assist in the location and mitigation of any resource or asset deficiency that is impeding the project.

At 350, an observer can repeatedly collect worker data over a period of time at one or more locations. The data collection device can record a date and time stamp for each worker task, activity or other report entered by the user, and also calculate the duration of each activity if the user enters start and stop entries for one or more activities. Upon the completion of data collection activities, at 355, all of the recorded data (e.g., sensor collected and user entered) may be transmitted to the central database for review and analysis. The data may be transmitted from the data collection device to the server wirelessly, or through a wired interface when the data collection device is coupled to a network.

Once synced to the network, at 360, designated users may validate the data prior to publication of reports. Validation may include reconciling the number or type of workers present or scheduled in an area or project with the actual number of workers observer. Any user entered discrepancies may also be compared with sensor readings. For example, if ten pipe fitters were assigned to a shift in one area, but the observed data indicated that only five boiler makers were present in the area, then the collected data could be flagged for review. A supervisor or manager may opt to clarify the number or type of workers that were present at the scheduled time with the observer in order to resolve any discrepancy between the scheduled and observed work activities. In an example, if a ten-hour shift is scheduled for an area and a single route for an observer requires two hours of time, an embodiment of a work measurement toolkit can flag or reject an attempt to enter a sixth route record during the shift. Any changes to collected data can be posted to the system with a request for approval or agreement by the observer.

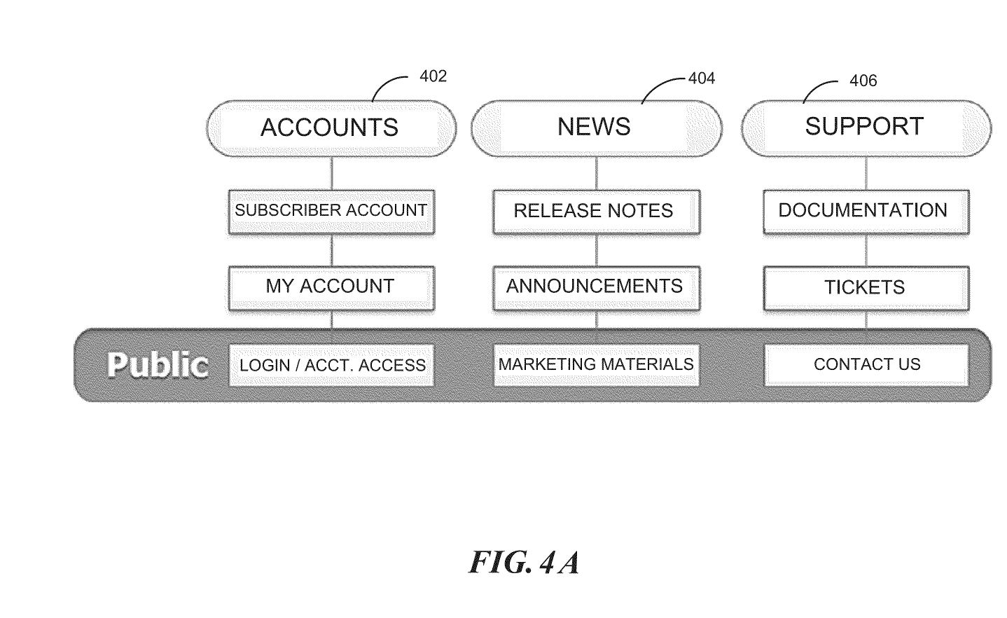

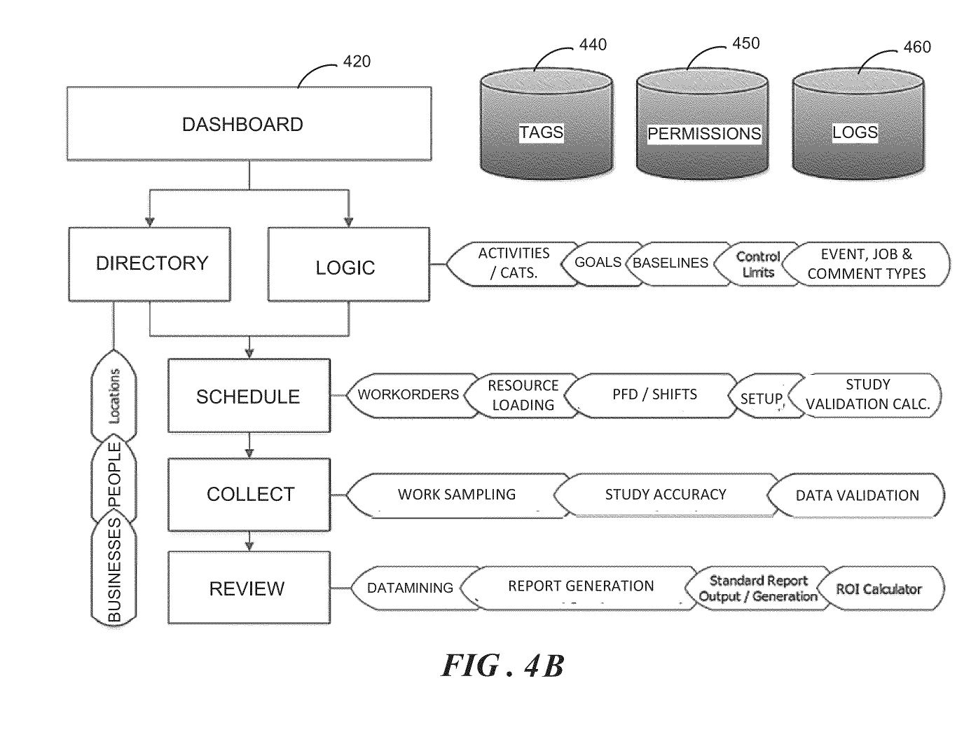

FIG. 4A depicts a block diagram illustrating an example of a user interface hierarchy for a work sampling tool kit, according to an embodiment. The user interface hierarchy may include separate sections for accounts 402, news 404 and support 406. The accounts 402 section may include subscriber account information, or specific user account information, along with a portal to provide account access (e.g., a login). The news 404 section may include release notes, system announcements, and public marketing materials. The support 406 section may include system documentation, an interface to enter tickets (e.g., bug reports) and public contact information.

FIG. 4B depicts a block diagram illustrating an example of a user interface hierarchy for a work sampling tool kit, according to an embodiment. The user interface may include a dashboard 420 that provides access to directory of logic modules. An example directory module may include interfaces for review or entry of businesses, people or locations. An example logic module may include interfaces for review or entry of activities (e.g., work categories), work measurement or performance goals, baseline metrics (e.g., industry benchmarks), control unit information, or event, job and comment types.

The directory and logic modules may also include or provide access to schedule, collect (e.g., data collection), and review modules. An example schedule module may be configured to receive or present work orders, resource loading information, PFD or shift information, schedule setup information. Additionally, the schedule module may be configured to include a study validation calculator that may provide an estimate of time, effort, or resources needed to produce a work measurement study of a requested confidence level. An example collect module may be configured to receive work sampling data, present work study accuracy information, and perform data validation on entered work samples. An example review module may be configured to perform data mining, report generation, standard reports, and present a return on investment (ROI) calculator.

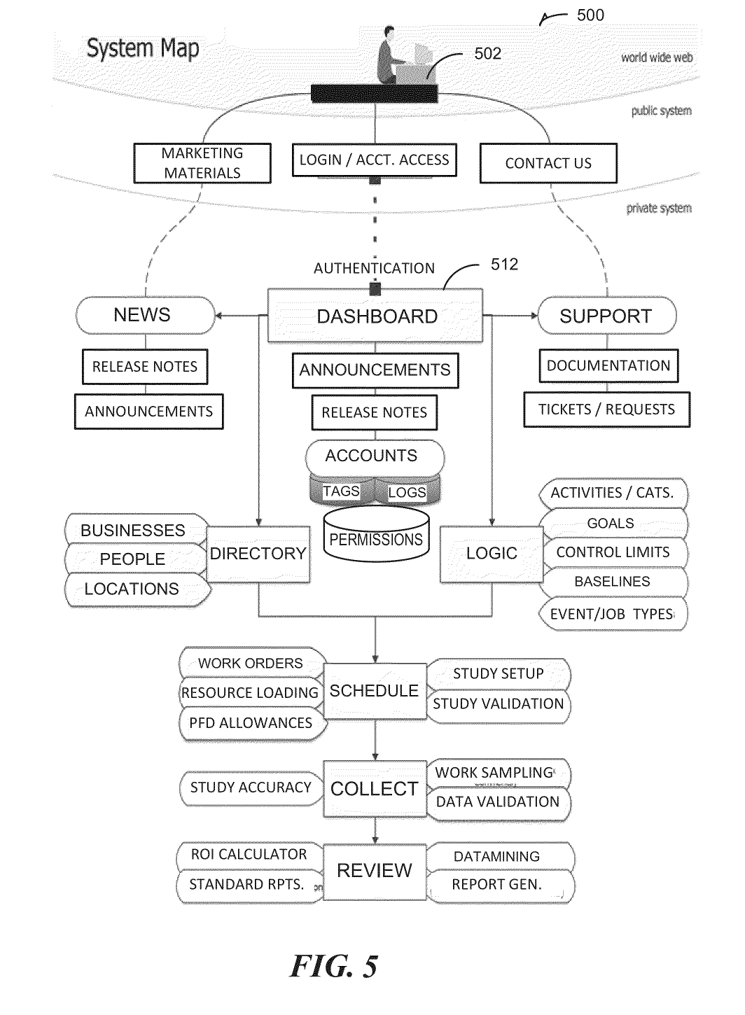

FIG. 5 depicts a block diagram illustrating an example system map 500 of a work sampling toolkit, according to an embodiment. The system map 500 includes a hierarchy of the modules and functionality illustrated in FIGS. 4A and 4B. A dashboard 512 may present a unified interface to a user 502. The dashboard 512 may provide access to the news, directory, logic and support modules.

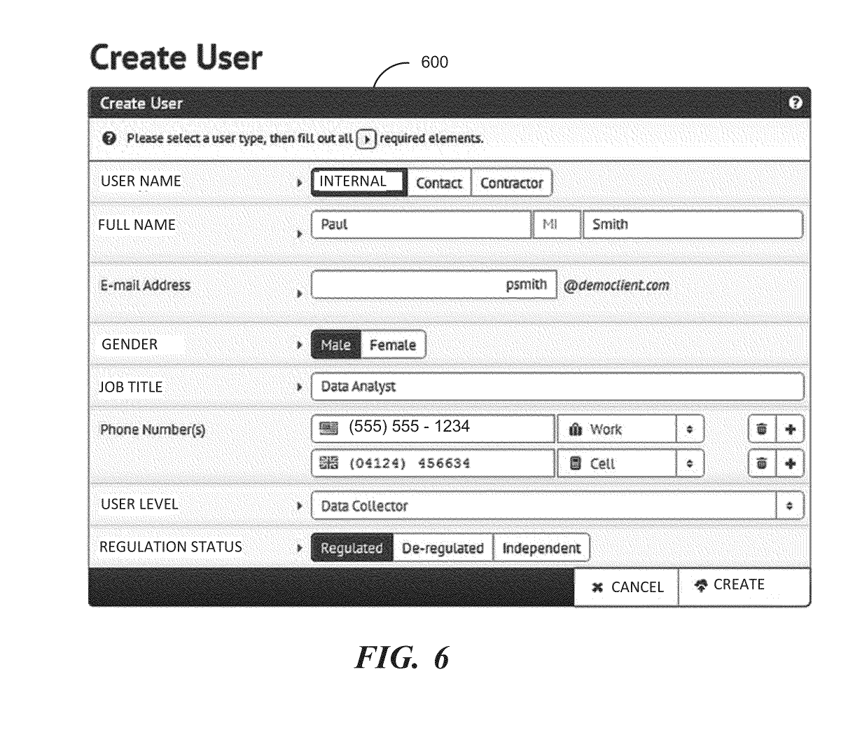

FIG. 6 illustrates an example user creation interface 600, according to an embodiment. The user creation interface 600 may allow a user to add or register a new user to a work measurement system, such as the directory module depicted in FIG. 5.

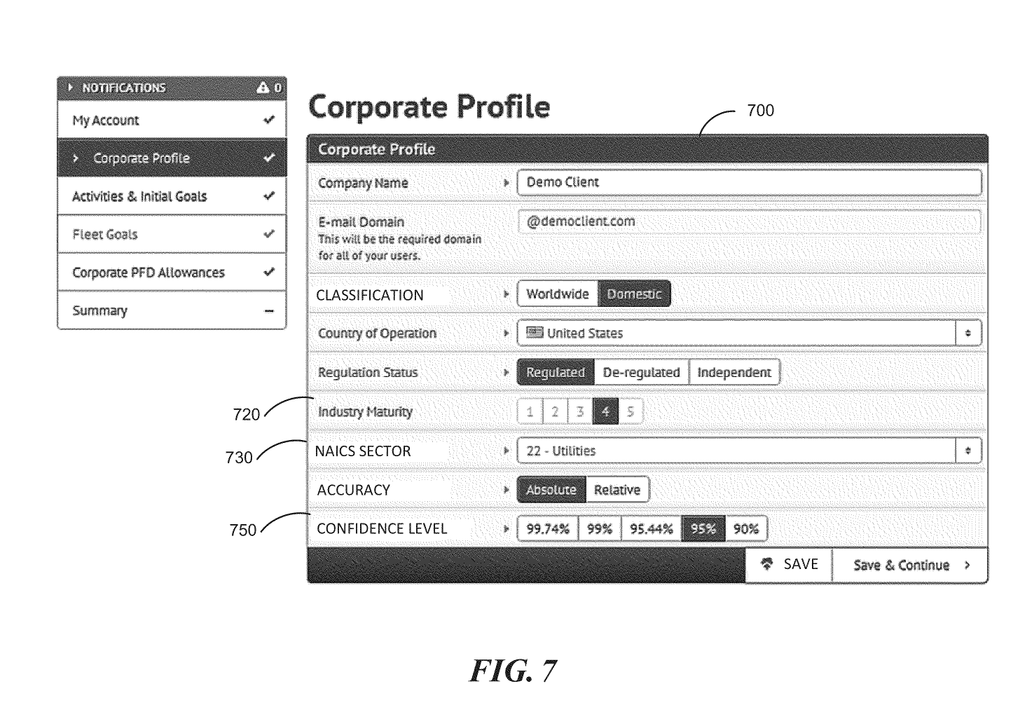

FIG. 7 illustrates an example registration interface 700, according to an embodiment. The registration interface 700 may provide a user with an interface to enter information related to the corporate profile of a company that is engaging in a work sampling project. For example, the use may provide specific information about the name, domain, classification, nationality, regulation status, maturity of the company. The industry maturity 720 may provide a mechanism to differentiate the sophistication of the company. For example, a fledgling start-up business may be ranked as a one, while a mature organization with efficient and standardized processes may be ranked as a five, with variations inbetween. The user may also indicate a NAICS sector 730 that is most closely related to the industry or business activities of the company. Additionally, the user may select an accuracy perspective 740 (e.g., absolute or relative) and a confidence level 750 that indicates a desired level of confidence the user desires the work sampling project to produce.

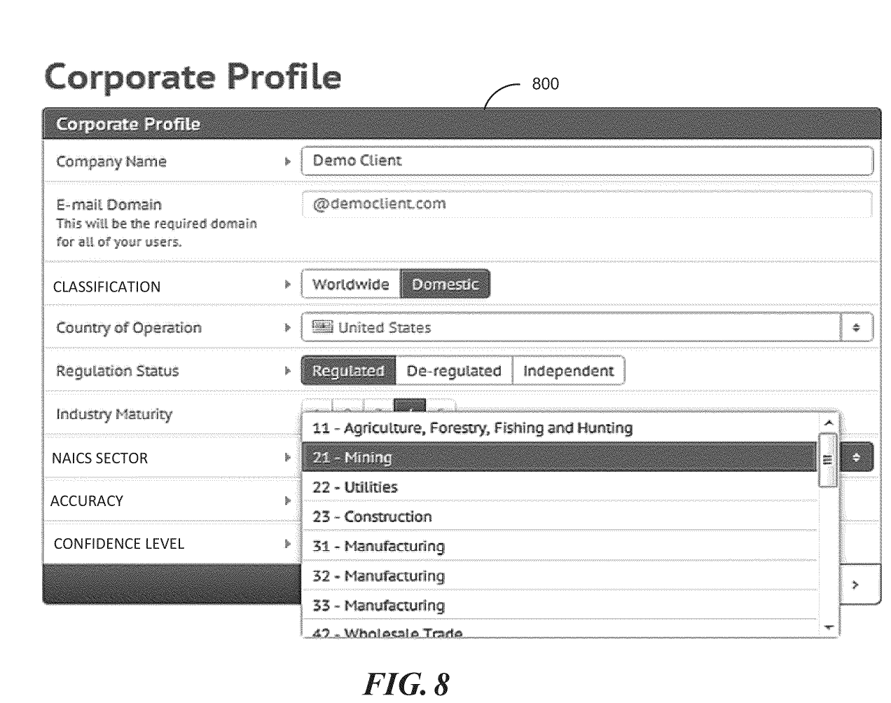

FIG. 8 illustrates an example of entering a standardized industry and labor classification code example registration interface 800, according to an embodiment. For example, a labor code may be defined in accordance with accepted industry types, such as the United States government's NAICS code or the U.S. Department of Labor's O*NET database. Accepted industry types may provide cross-references that may facilitate accurate data mining between industries or organizations by providing a common metric or language for work measurements.

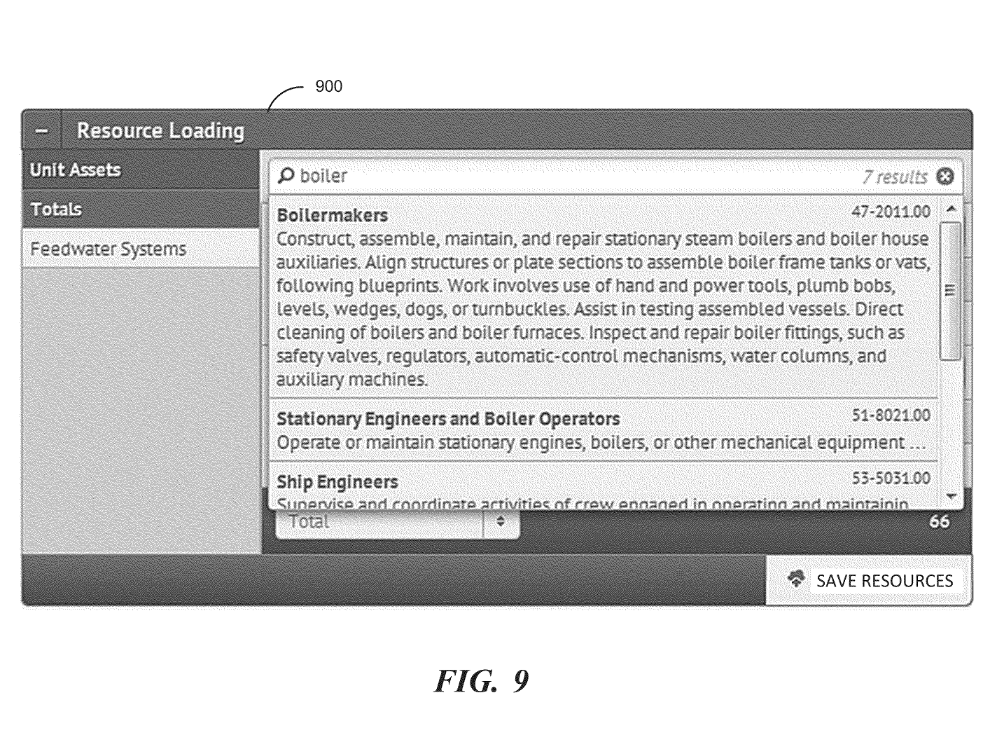

FIG. 9 illustrates an example resource loading interface 900, according to an embodiment. The resource loading interface 900 may provide a listing of various types of workers that may be engaged in a project. For example, if the project calls for one or more boilermakers or boiler operators to perform work, a user may search for the term “boiler” and receive, through the resource loading interface 900, a list of resources that include the term “boiler.” In this manner the selection of resources may be made consistently throughout the project by presenting a data collector (e.g., via a user interface on a mobile collection device) with expected workers, locations, and assets that the data collector should encounter during a data collection route.

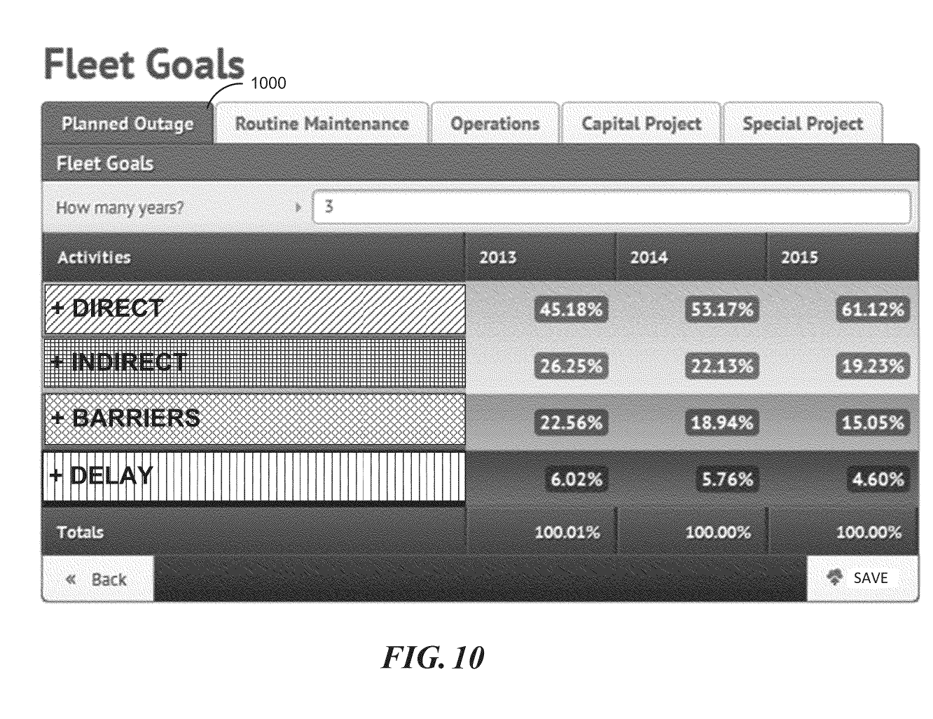

FIG. 10 illustrates an example of a fleet goal interface 1000, according to an embodiment. For example, the fleet goal interface 1000 may include displaying a three-year productivity fleet goals to a user. The productivity activities may be set by the user to have goals for planned outages during the years 2013, 2014, and 2015, for each category of direct work (color coded: green), indirect work (color coded: yellow), barriers (color coded: orange), and delay (color coded: red). Productivity goals may be associated with each activity and category by goal: baseline, initial, and multiyear and categorized by fleet, event type. The interface may provide specific users with an interface to review and set desired upper or lower control limits for meeting those targeted goals.

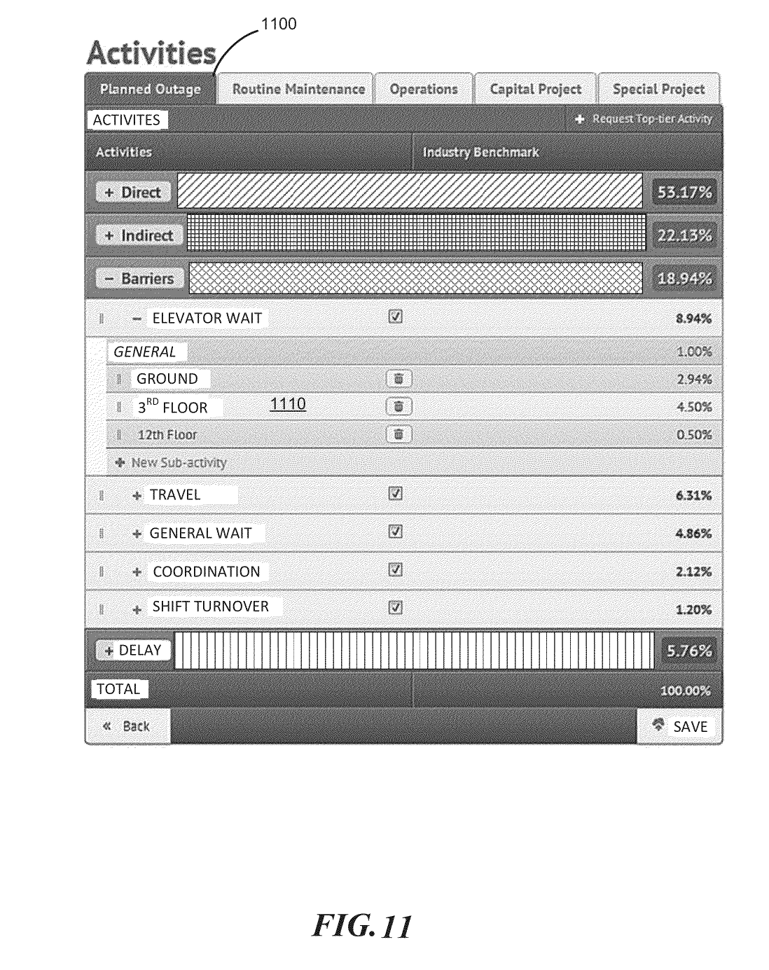

FIG. 11 illustrates an example of an activity user interface 1100, according to an embodiment. The activity user interface 1100 may enable a user to quickly and efficiently view or enter data and information related to observed or anticipated activities. The user interface 1100 may be generated from one or more setup tables created during an initial project setup. Color-coded work sampling categories for direct work (green), indirect work (yellow), barriers (orange), and delays (red) may aid in the ease and identification of data collection for accurate results. These colors may remain constant throughout the system for work sampling studies across different industries on a single platform.

In an example, the user interface 1100 may provided users with access to setup site, unit, and multi-level hierarchical asset or activity outlines that can be referenced as: a parent, child, and grandchild, etc., levels for detailed work package evaluations, standards creation, and knowledge base use. By having this capability, the users may develop a knowledge base for any specific work package for future benchmarking, scheduling, resource loading, and cost estimation.

In an example, the user interface 1100 may provide tools that let the user enter customized activities and sub-activities for an in-depth root cause analysis. An example of this customization may include a data collector who takes a reading on a barrier event 1110 (color coded orange), for example an “elevator wait” activity that consumes the time of one or more workers (e.g., is a barrier to accomplishing work). If the elevator wait is occurring on the third floor, a data collector may create a sub-activity titled “3^{RD} Floor” and specifically indicate the location of the activity barrier. The hierarchical classification of the event data can provide users with the information for improvement implementation and deployment of solution to impede further work barriers, for example requesting elevator repair, or relocation of a work activity to a different floor.

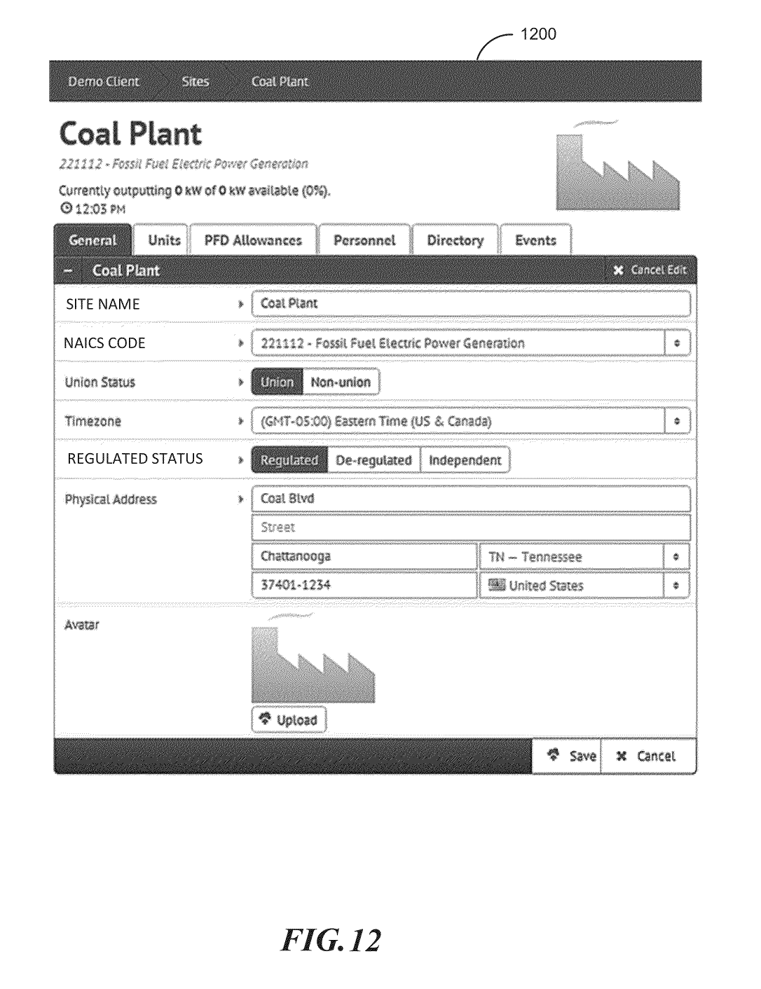

FIG. 12 illustrates an example of a site setup screen 1200, according to an embodiment. The site setup screen 1200 may provide an interface for a user to enter site information. In the depicted example, a hypothetical electricity-generating coal plant located in Chattanooga, Tenn. is input as a union plant that is regulated by a government entity. In various tabs of the site setup screen 1200 a user may specify further site details such as units, personal fatigue and delay (PFD) allowances, personnel, directory, and events.

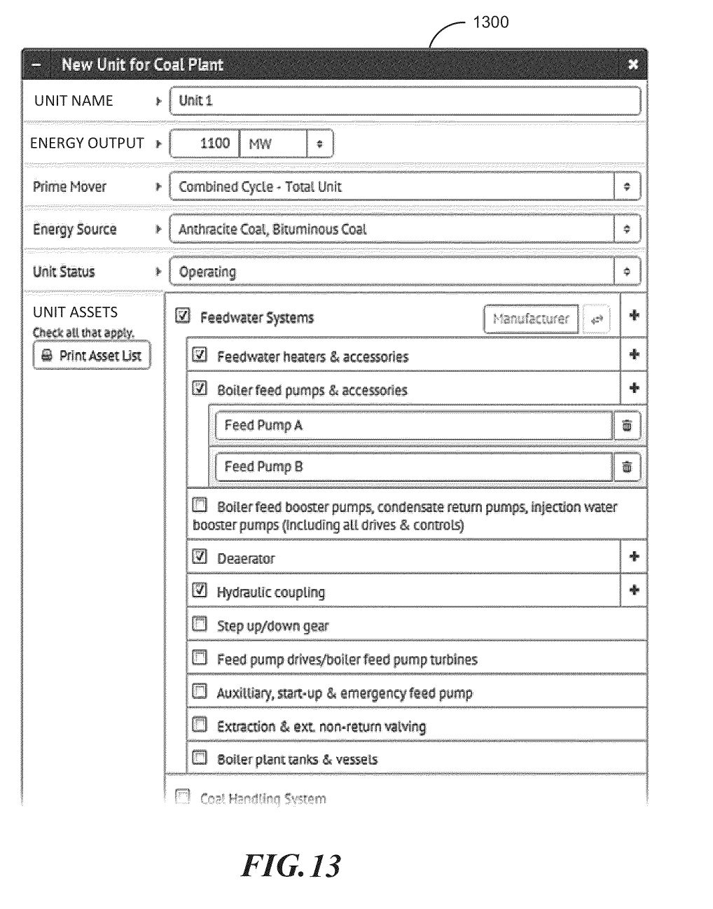

FIG. 13 illustrates an example of a unit creation tab 1300 of the site setup screen depicted in FIG. 12, according to an embodiment. The unit creation tab 1300 may provide an interface for a user to enter unit specific information. For example, the hypothetical electricity-generating coal plant may have multiple coal burning units. Each unit may have a specific output value, energy source, status value, and assets associated with the unit. This information may be entered into an example work measurement system such that a data collector user is presented with all appropriate information about a specific unit before data collection begins, and so that the data collector does not need to enter the information during data collection activities.

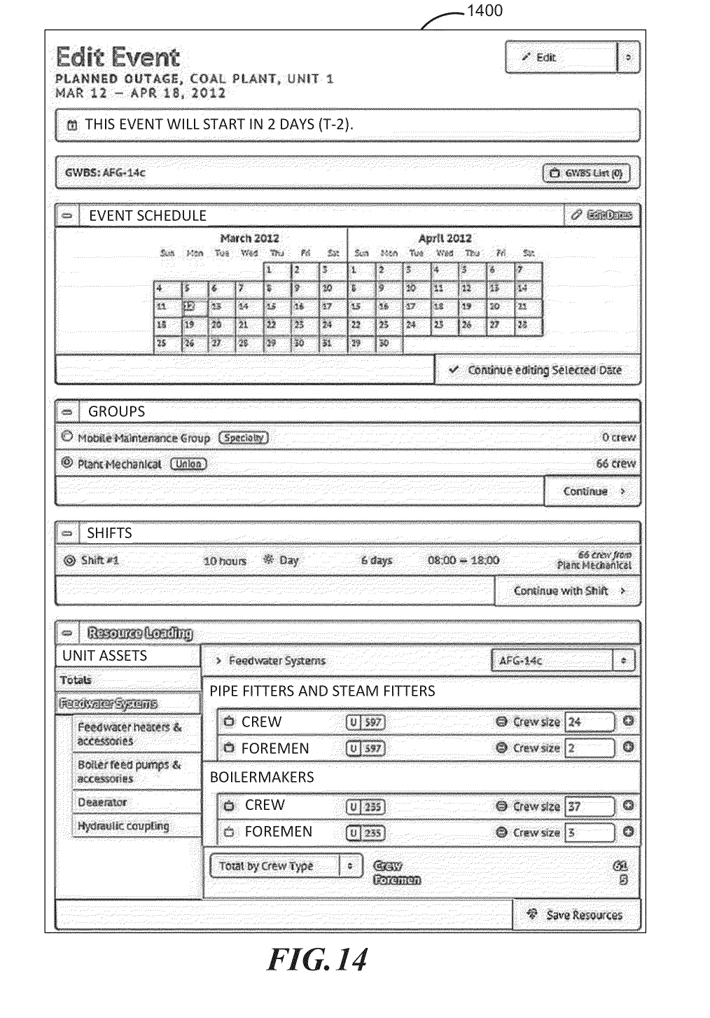

FIG. 14 illustrates an example of an event interface 1400, according to an embodiment. The event interface 1400 may provide a user with an interface to assign in-depth resource loading details by event type and work package in order to provide an accurate knowledgebase establishing specific work measurement standards. For job-scheduled resources the user may create an event at a site, using a calendar tool. The day(s) entered may appear in a highlighted color to designate the range of dates for a scheduled event. Individual groups of workers may be specified for work during the event (e.g., a mobile maintenance group or a plant mechanical group). One or more shifts may be specified for work during the event. Unit assets may also be pre-loaded into the event. For example, the event may specify that twenty-four pipe and steam fitters, two fitter foremen, thirty seven boilermakers, and three boilermaker foremen will be present at the feedwater system.

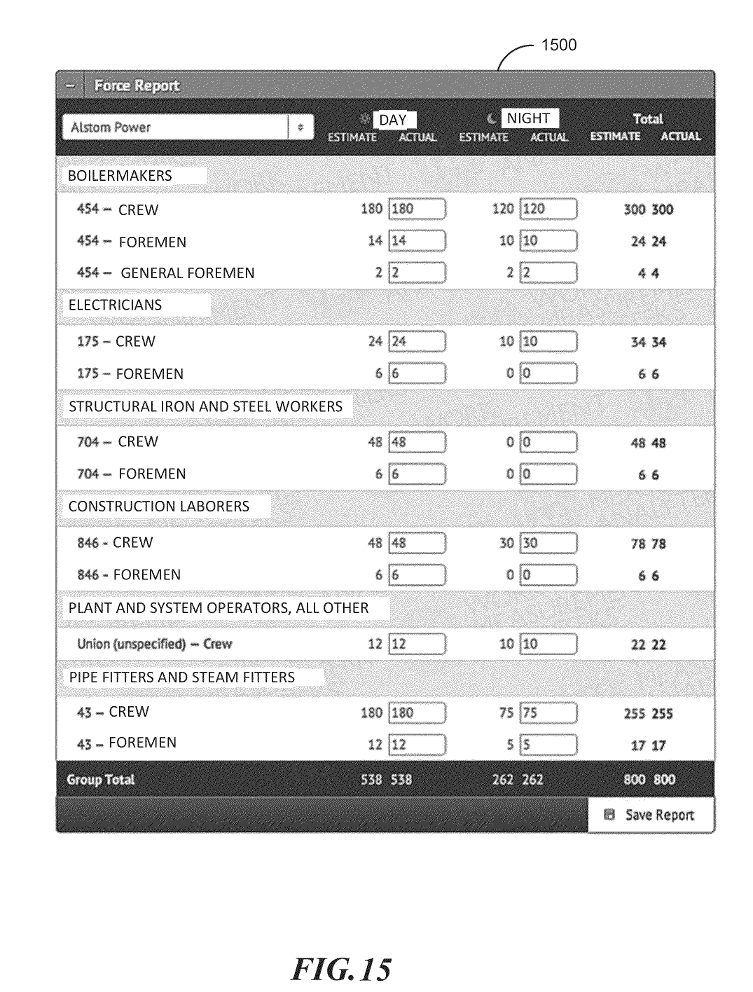

FIG. 15 illustrates an example of a work force interface 1500, according to an embodiment. The work force report interface 1500 may provide a user with the option to enter which group or groups of workers are scheduled (e.g., estimated) to work during an event. Shifts may be selected for when (e.g., time or shift), where (location or site), and how long during the event, each crew of workers will perform an activity. Actual worker shift requirements may be based on a previously configured estimate for the event. The work force interface 1500 may also indicate an actual number of workers in each group that were present for a shift. The actual number of workers may be determined based on data collector entered values, or sensor readings corresponding to a number of badges detected for each group during a shift or data collection route.

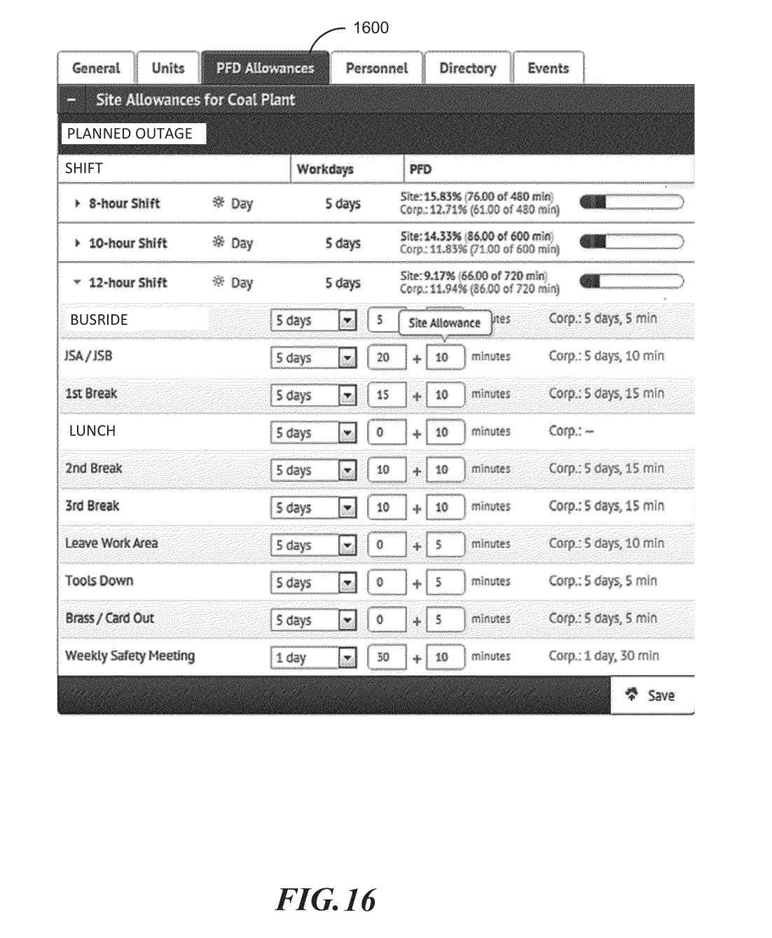

FIG. 16 illustrates an example of an interface 1600 to track PFD, according to an embodiment. The interface 1600 may provide a user with the option to enter PFD values for a site, and to enter site-specific barrier allowances for accurate comparisons between specific groups and crafts working on the same event. Tracking PFD provides for valid comparisons between actual available work time and periods with no available production time per shift for each group or craft evaluation.

In an example, PFD comparison between two groups of workers: Group A and Group B that each includes one-hundred workers for a ten-hour shift. During shift time, the work rules for Group A enforce two hours of break (non-work) time, and the rule for Group B enforce a ninety-minute break time. For both groups, their direct work productivity measurement is 35%. Factoring in the site specific barrier allowances creates the ability to identify that Group B as available to work fifty hours more during the shift time and has 17.5% more productivity than Group A. By including and factoring in the site specific barrier allowances a realistic and accurate data comparison for the evaluation of performance between Group A and B may be provided.

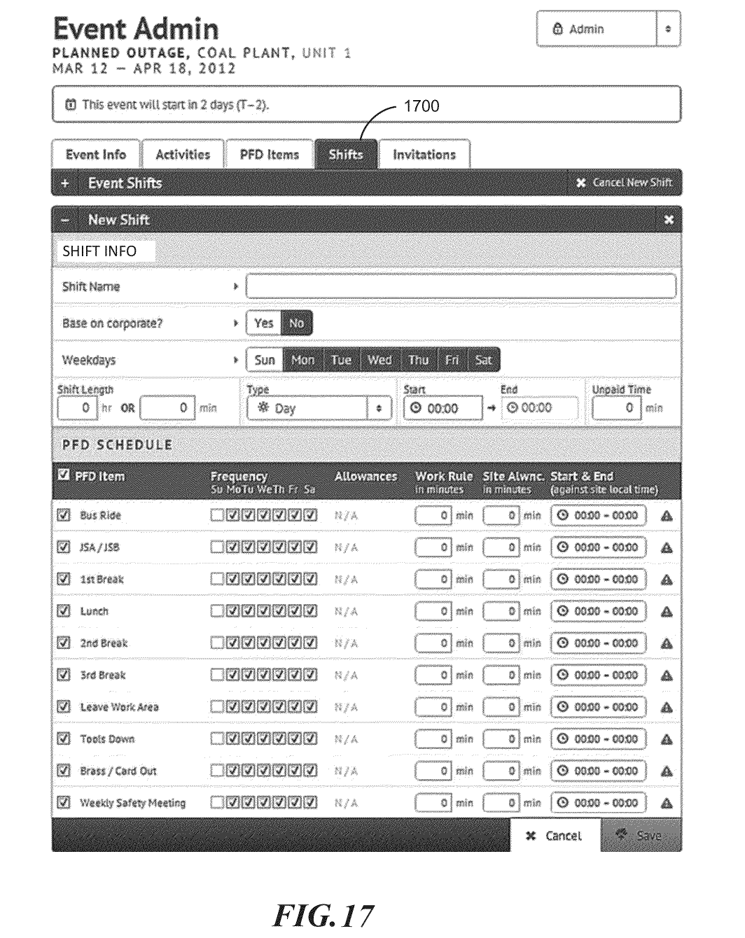

FIG. 17 illustrates an example of a shift interface 1700, according to an embodiment. The shift interface 1700 may provide detailed shift information, for example, specific PFD schedules for non-work activities that may include: bus rides on or to and from a site, JSA/JSB, a first break period, lunch, second or third break periods, time to leave a work area, time for tool storage, time for punching in or out (brass/card in/out) and a daily or weekly safety meeting. PFD data may include time allocated by contract or union agreement work rules or by site specific allowances. An example of a site specific allowance may include an extra ten-minute bus ride to and from a work location at a large oil refinery that is required each day before the workers can begin working.

In an example, an observer may be prevented from entering a work observation record indicating that a worker is not working during a scheduled break period. Because a scheduled break period is already accounted for as non-working time there is no need for a separate data entry indicating that work is not being done. However, an observer may enter a work data observation that a worker is performing a task during the scheduled break period. The system may request a confirmation of the work during the break period, but allow the observer to confirm or enter the observation after acknowledging the discrepancy with the schedule. Similarly, if more workers are observed at a work site than were scheduled, the system may prompt an observer to input a group or craft to be associated with the unscheduled workers such that the work activity can be properly categorized for later review.

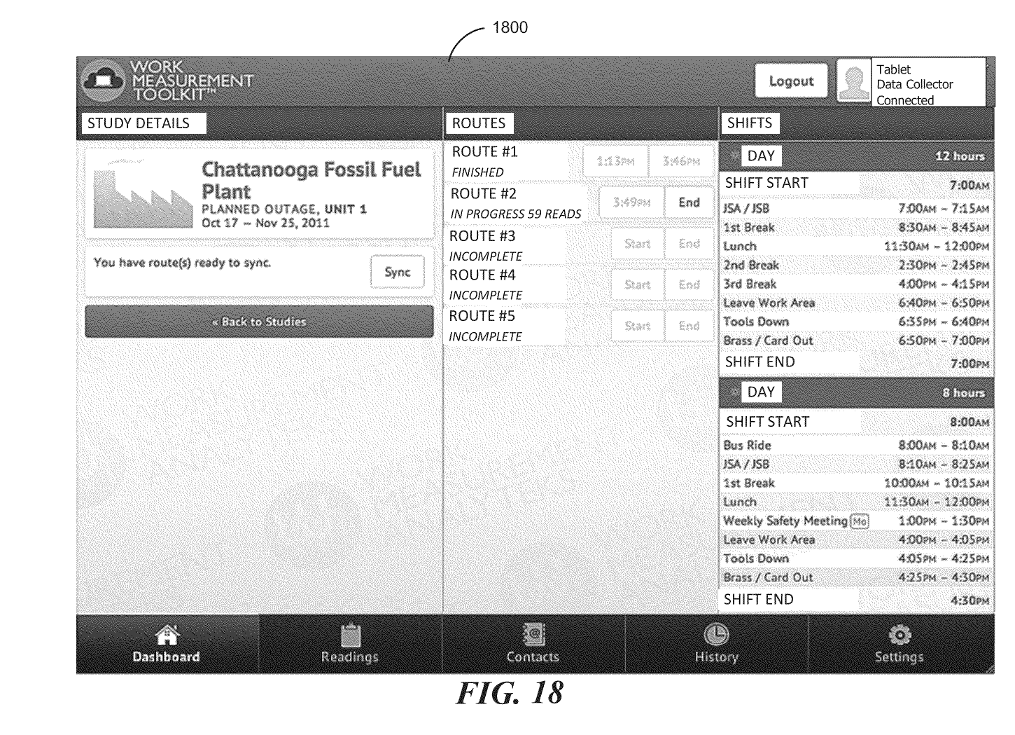

FIG. 18 illustrates an example of a mobile-device application interface 1800, according to an embodiment. The mobile-device application interface 1800 may provide a data-collection interface with a decision matrix configured on the mobile device for ease of accurate and streamlined data collection in a field (e.g., work location) environment. Examples of a mobile device may include smart phones or handheld tablet computers such as the Apple® iPad®, BlackBerry® PlayBook®, Microsoft® Surface®, or Google® Android® tablet devices, a laptop computer, or other portable computing device.

After a user's project data is entered into the system, the data may be synced to an Internet or private cloud-based network server application by any network connected computing device. An example embodiment may provide a centralized data store or database for data mining capabilities with study final results according to NAICS code and sub-codes for industry specific internal, industry, and best practices benchmarking that is accessible from any device with networking capabilities that would allow the device to connect to the cloud based server application.

The mobile-device application interface 1800 may include a plurality of route for data collection at the exemplary Chattanooga Fossil Fuel Plant. The routes may be utilized during one or more shifts when workers are present at the plant. The mobile device application may provide multiple tabs for navigation, including, for example, a dashboard area, data readings tab, a tab for contacts associated with a site or company, a tab for historical data from completed routes, and a device settings tab.

In an example embodiment, a work measurement system-architecture provides users of a mobile device the options to toggle between areas or asset hierarchy, group, resource, and data Collection interfaces. Data entry may be setup by a predefined structure wherein the settings of one category predetermine selections for following categories. For example, once a work area or asset hierarchy is selected, the system can filter the groups based upon an initial system setup, and offer only the groups applicable for that selection through a sophisticated decision matrix display. The system may filter entries from various categories, for example: area or asset hierarchy, group, or craft. At any given instance during data collection or review, each section may include an ALL button, to allow users to access all applicable lists of desired data in real time.

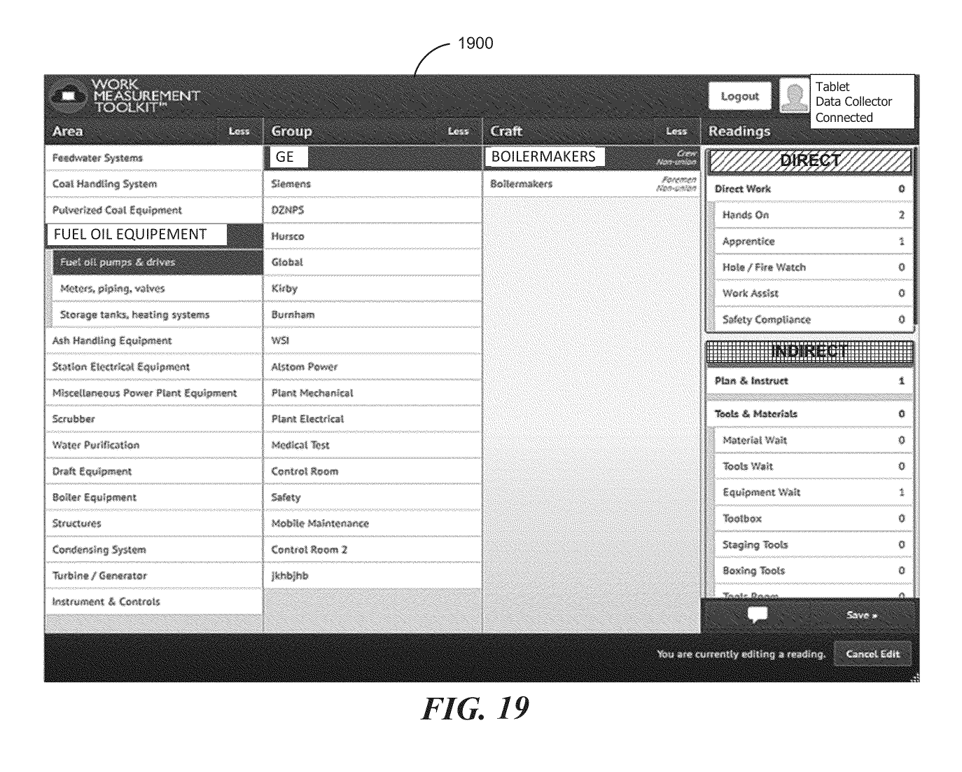

FIG. 19 illustrates an example of a data collection interface 1900 of an exemplary mobile device application, according to an embodiment. In an example, a user may initiate a data recording in the data collection interface 1900 by selecting a “fuel oil equipment” area, specifically, a location with “fuel oil pumps and drives.” In the area the user has noticed a group of “GE” workers who are categorized as belonging to the craft of boilermakers. The data collection interface 1900 indicates that there are two hands-on workers and one apprentice worker. The craft column selection indicates that the two hands-on workers and the apprentice worker are non-union crew members that are actively engaged in work (e.g., a direct activity—color coded green). In the data collection interface 1900 also indicates that the user has observed and recorded that one worker is waiting for a piece of equipment (e.g., an indirect delay—color coded yellow).

The data collection interface 1900 also illustrates an example where a mobile data collection system only presents craft options for workers from a group that is scheduled to be in an area. For example, there may be workers from any of the other groups listed in the group pane in the “Fuel Oil Equipment” area, but because the observer selected the “GE” group, only the boilermakers from that group are included in the craft pane.

In an example, the data collection device may determine that the data collector is located in “fuel oil equipment” area, and more specifically, in the location with “fuel oil pumps and drives” based on GPS positioning or received sensor data from one or more area markers. The data collection interface 1900 may then automatically select the corresponding area and sub-area for the user in response to the determination of the specific location of the data collection device. Additionally, upon detection of one or more workers that are assigned to a specific group (e.g., boilermakers who are part of the GE group) the data collection interface 1900 may then automatically select the corresponding worker group and craft for the user.

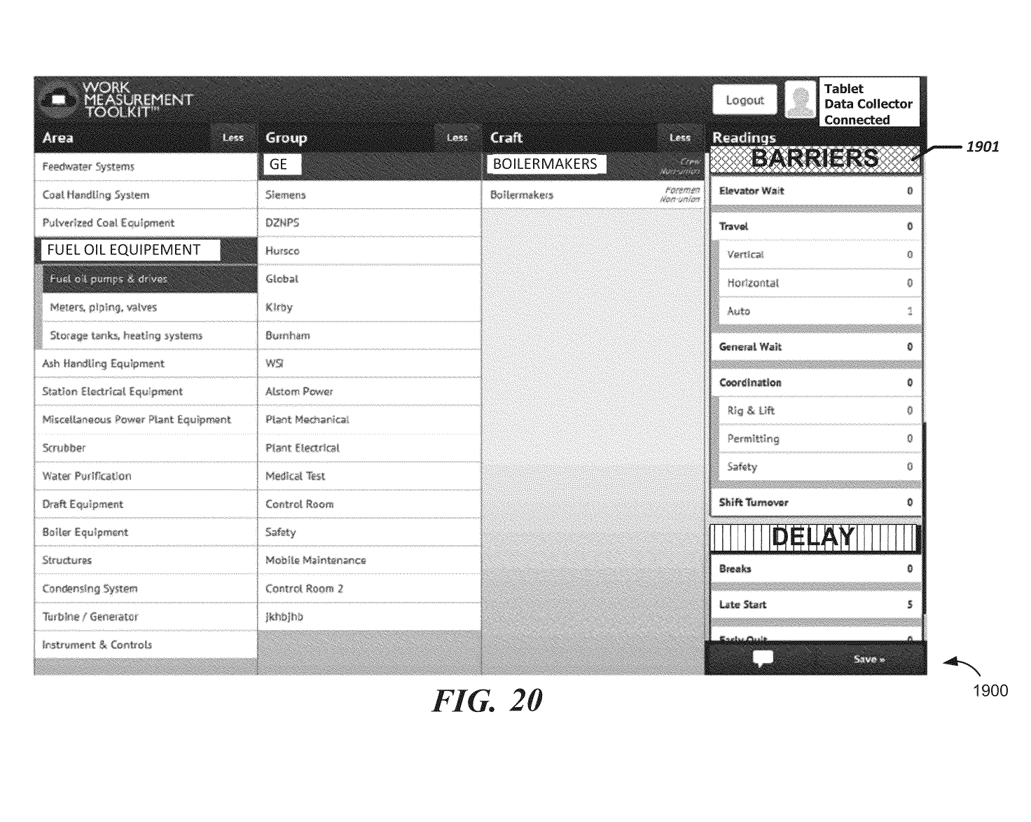

FIG. 20 illustrates a further example of the data collection interface 1900 depicted in FIG. 19. The data collection interface 1900 depicts an example where a user has scrolled down in the “Readings” column to enter “Barriers” 1901 (color coded orange) and “Delay” information (color coded red). The user in this example has indicated that there is a unit of automobile (auto) travel that is preventing one activity. Additionally, the user in this example illustration has entered five late start delays (where five work units were absent or unable to begin work at a scheduled period).

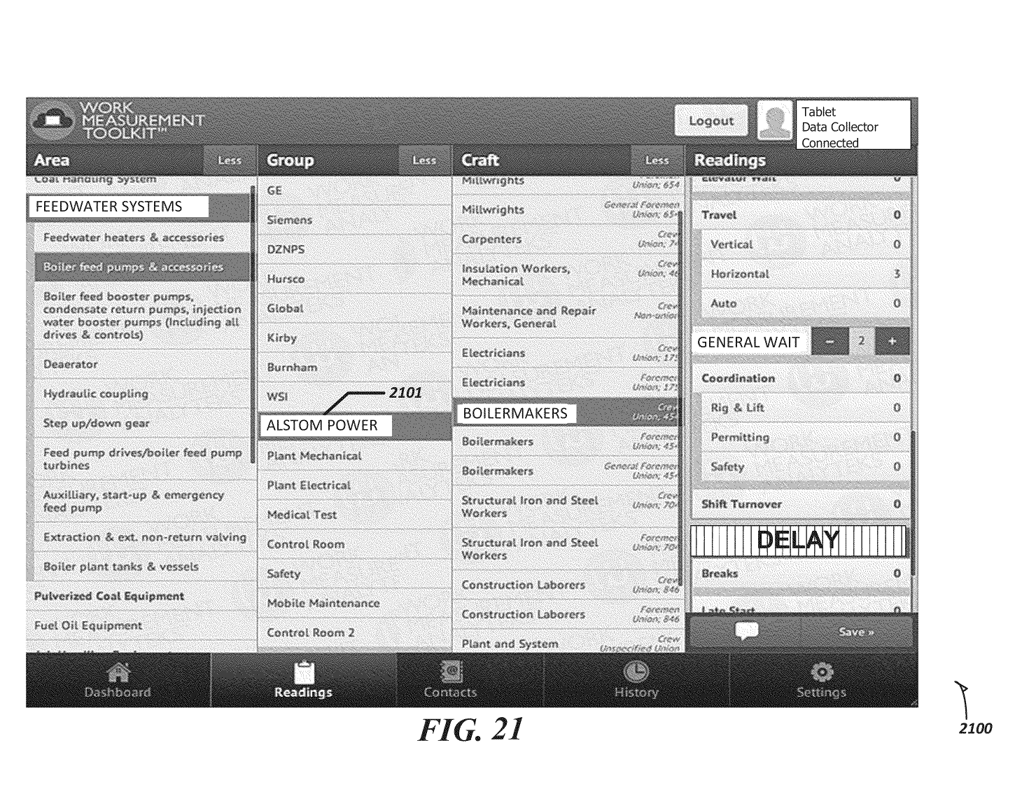

FIG. 21 illustrates an example of a data collection interface 2100, according to an embodiment. The data collection interface 2100 indicates a data collection observer-user has recorded two units of general wait for a crew of union boilermakers associated with an “Alstom Power” group 2101 at a “Boiler feed pumps and accessories” location. In response to the entry of the general wait condition a notification, the work measurement system may send a message (e.g., an e-mail, page, instant message, or text message) to a supervisor of the group, or a project manager with an indication that a project delay is occurring. In this manner, the supervisor of the group or the project manager is presented with an opportunity to immediately attempt to address the condition causing the delay.

In contrast with the “GE” group as depicted in the example data collection interface 1900 of FIG. 19, the “Alstom Power” group includes a plurality of different craft workers at a single area. An observer may first select any pane to narrow down selections for a data observation. For example, the observer could first select “boilermakers” from the craft pane, and be presented with any area where boilermakers are scheduled to be present and only those groups that are scheduled to provide boilermakers. In an example, when a plurality of different craft workers are detected in a single area based on sensor data received from worker badges only the groups or crafts of the works present may be displayed for selection or confirmation by the data collection observer-user.

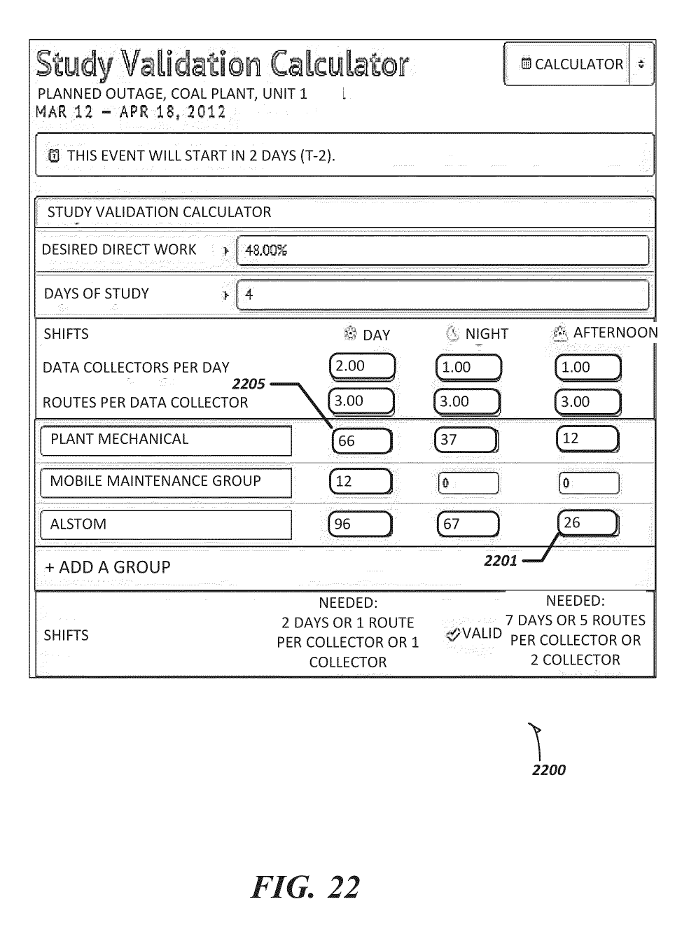

FIG. 22 illustrates an example of a study validation calculator interface 2200, according to an embodiment. A mobile data collection device or a cloud-based network server application may provide interactive feedback prior to, during, and after work sampling data collection based on job set up calculations. Providing real-time feed back to a user collecting data can help to ensure that the study accuracy for overall study validation is improved in order to maintain a predetermined confidence level.

In an example, a work study toolkit may include an automatic system intelligence module that evaluates the accuracy and confidence levels of work sampling data readings based on preconfigured data collection goals. The work study toolkit may provide a data collector with instructions for achieving a goal, and notifications if data collections are not on pace or once a desired goal is attained. Evaluation of work sampling data calculations may be based upon predetermined confidence level and study validation standards. Accuracy of the data may depend upon the representativeness of the study. For example, what is measured is a function of the number of observations, the coverage of work cycle, and the relative size of the sample with regard to the population.

Data reading boxes 2205 outlined in green may indicate that data entered into the collection device will yield a valid study. Boxes outlined in red 2201 may indicate that data entered will not yield a valid study. An example embodiment may also recommend or suggest example data points that may be gathered in order to create a valid study. For example, the user may be prompted to perform a minimum number of routes at a site that include a specific area where a high confidence level is desired for the study. The user may also be prompted to perform a minimum number of routes during multiple work shifts or in multiple areas.

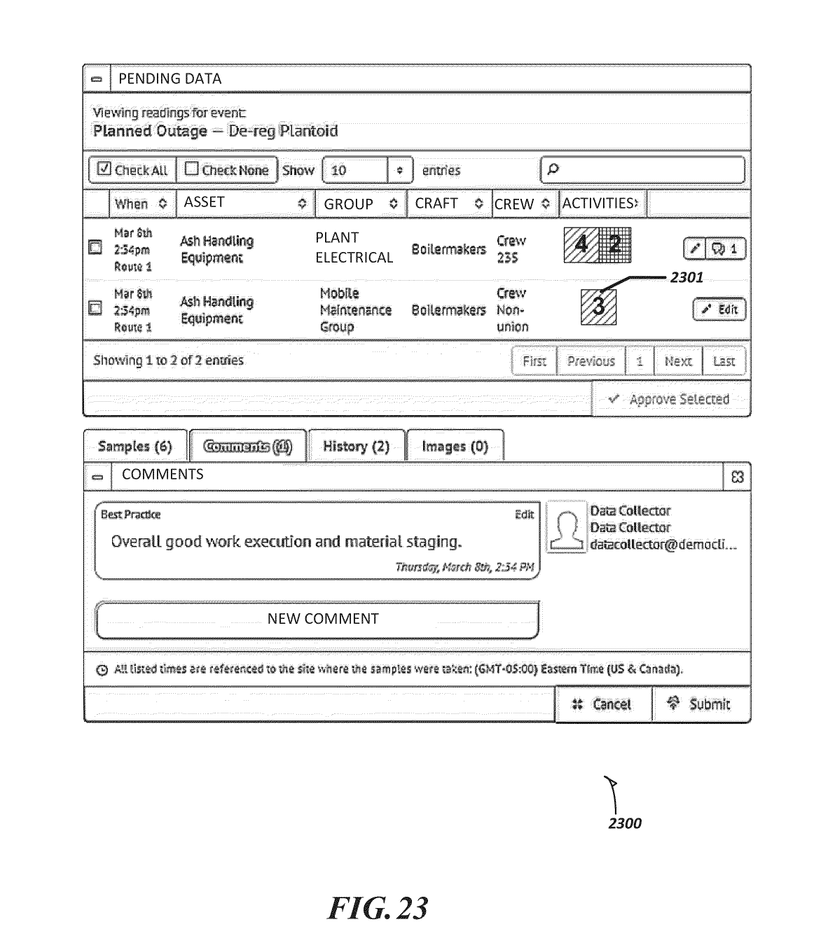

FIG. 23 illustrates an example of a pending data review interface 2300, according to an embodiment. In an example, a data review module may utilize statistically generated algorithms to predict anomalies in collected data. The pending data review interface 2300 may notify users of upper and lower control limits for desired data collection outputs, targets and goals. Additionally, the pending data review interface 2300 may also flag human errors or suspected bias in data collection. One or more users may receive email alerts or other notifications if work measurement samples indicate encroachment upon goals or errors in the data collection process. In this manner real-time feedback can be provided to an on-the-ground data collector, as well as a project manager or supervisor who is analyzing or later reviewing the data collection practices. In an example, a data collector may provide comments that can indicate the level or quality of the observed work or assets in addition to the objective work observations.

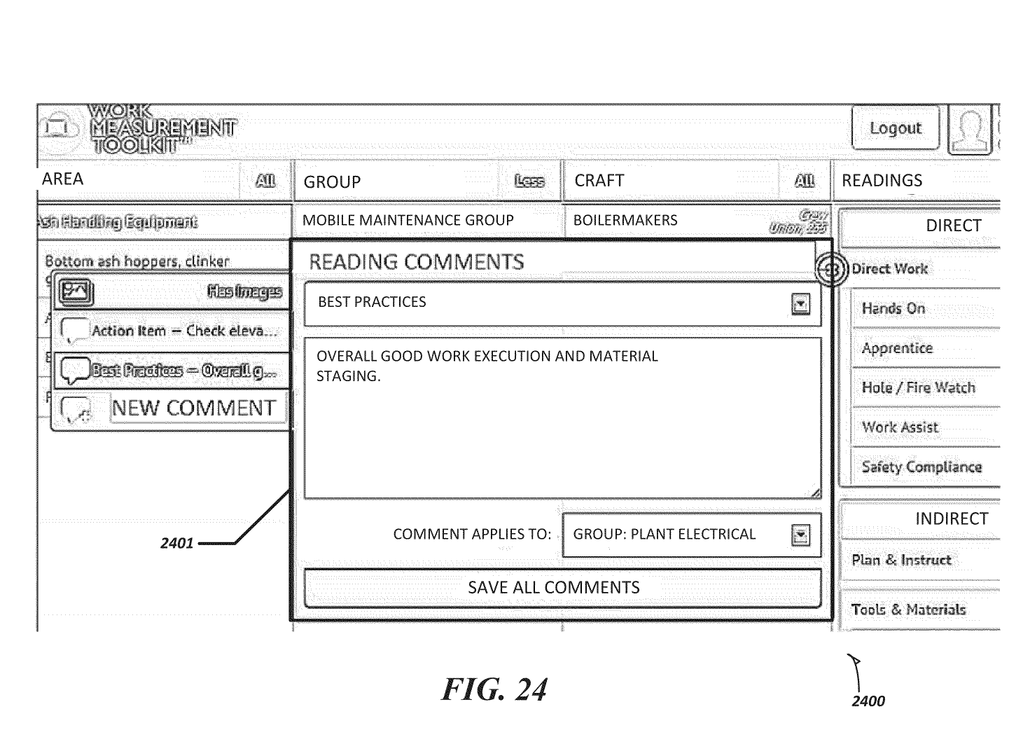

FIG. 24 illustrates an example of a data reading comments interface 2400, according to an embodiment. A data collector may enter notes in a comment box 2401 to provide context to specific data readings. For example, if a data collector observes a new or properly executed “best practice” work activity, a note can be entered to flag the data reading. The comment or suggestion may also be associated with a specific group or area where the commented reading was observed.

An example embodiment, a work measurement system can provide an interface, such as data reading comments interface 2400, for users to link real-time comments, suggestions, and images directly to work sampling data point collection readings for use in evaluation of the overall study, and root cause analysis during future data mining and for report narrative content generation. Users can select a comment icon in the top right corner of the interface, classify the comment, and tag it to a system specific category. The comment can be saved and transmitted to a project database immediately, or at the completion of the data collection route. Suggestions may be attached directly to a comment for better analysis of how to improve worker productivity and quality of work life. Comments can be attached or associated with specific categories, for example: groups, crafts, or areas.

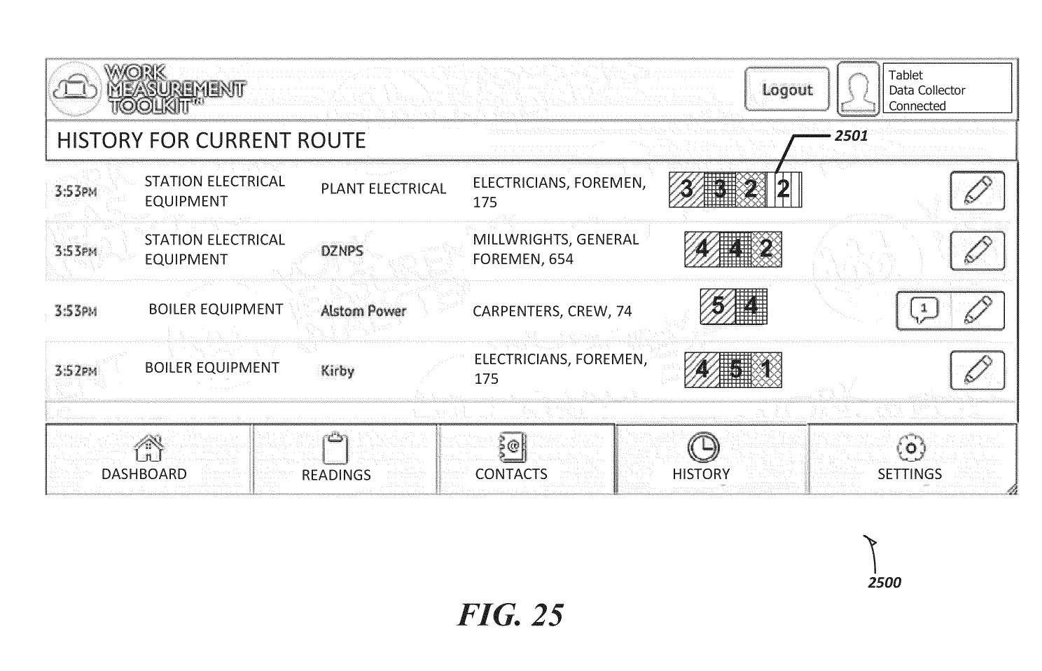

FIG. 25 illustrates an example of a mobile data collection interface 2500 displaying historical route collection data, according to an embodiment. The interface 2500 may include multiple data collection entries. For example, data collection entries may include: the time a data event was recorded, the location of the event, the group of workers involved with the event and the type of craft (worker type) that were present. If multiple event types were recorded at a single location, for an individual group, the number of each color-coded category can be summarized for the event. A comment indicator may be included if the observing data collector has included a comment, picture or other additional data. An editing icon may be included in the interface to allow revisions to specific data events.

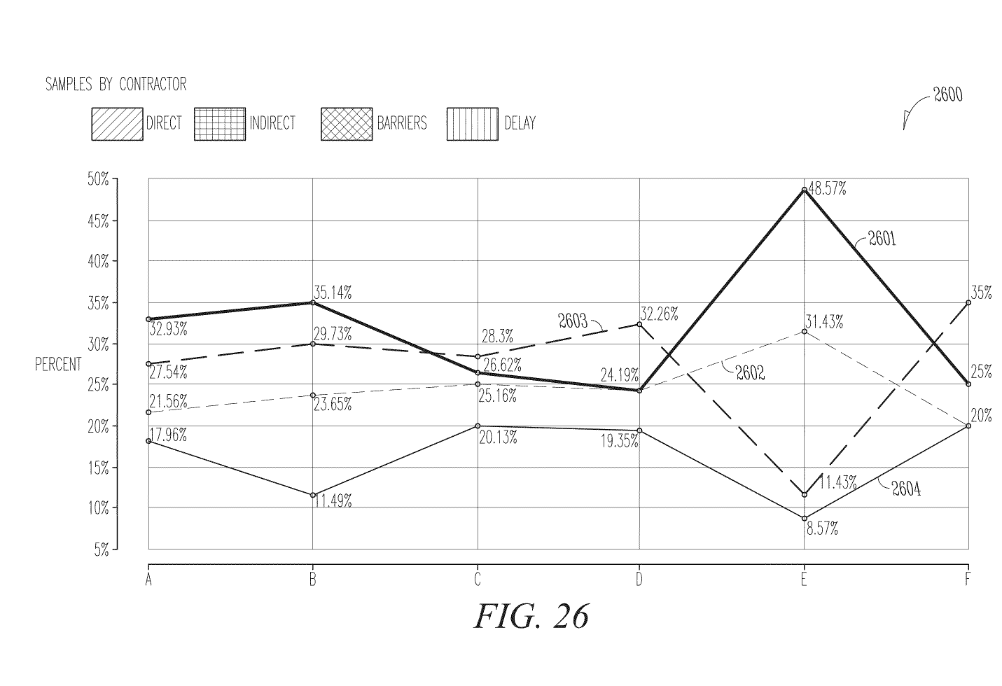

FIG. 26 illustrates an example line chart report 2600 organized by contractor groups, according to an embodiment. Six different groups A-F (e.g., contractors or maintenance personal) are represented, each with a color coded data point for each of the four data collection categories. As illustrated, Group-E had both the highest number of direct (green) data samples 2601, and the lowest number of delay (red) events 2604. Group-F included the highest number of barrier (orange) events 2603. Indirect events (yellow) 2603 are also presented.

Example reports may be formatted in a doughnut chart format and organized by the category of the samples collected on each of four data sample collection days of an individual work week or, in another example organized by contractor groups.

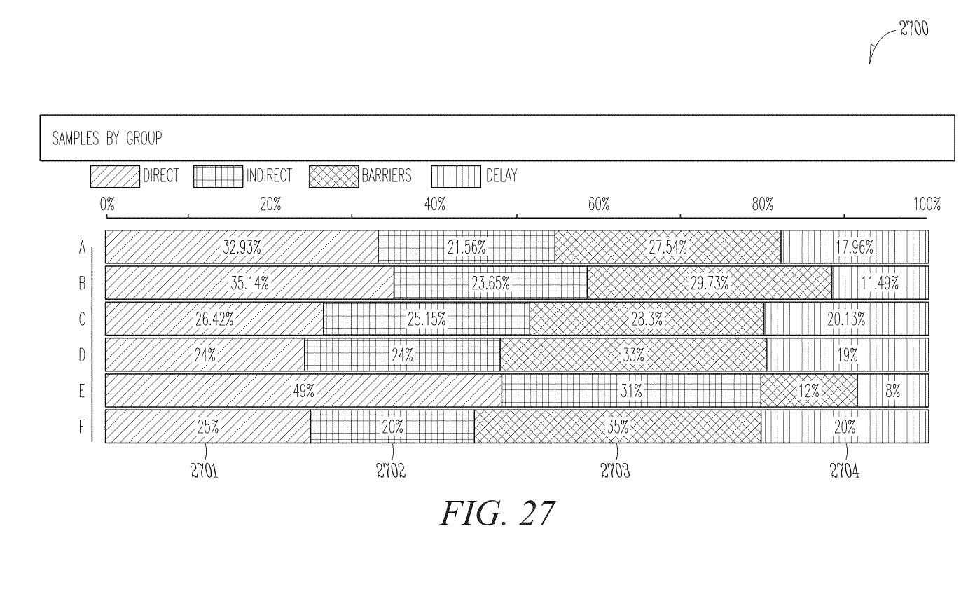

FIG. 27 illustrates an example report 2700 in a bar chart format, according to an embodiment. The performance of the different groups (A-F) may be divided into four color coded work sample categories: direct 2701 (green), indirect 2702 (yellow), barriers 2703 (orange) and delay 2704 (red). An example work measurement system may include a report module configured to automatically generate reports that include any delays encountered during an observation to the group or craft where the delay was observed. For example, the Group-C and Group-D experienced a delay of at least 20%, as shown in FIG. 27, and may receive a report indicating the observed indications or reasons for this delay.

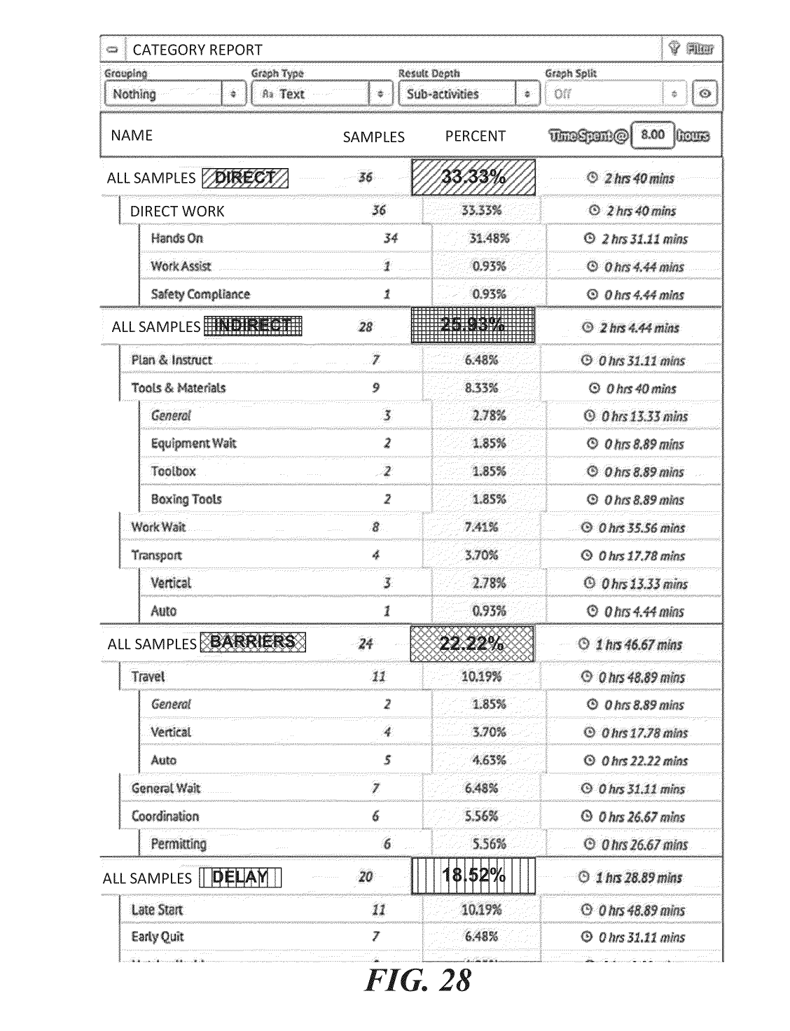

FIG. 28 illustrates an example category report 2800 in a table format, according to an embodiment. Work samples may be grouped into four color coded work sample categories: direct (green), indirect (yellow), barriers (orange) and delay (red). The percentages derived from data collection may be equated with time of each activity and utilized in the generation of report analysis.

An example embodiment may utilize standardized industry and labor classification codes, industry type code or any existing labor or workforce database to cross-references data collection entries for later consistent and accurate data mining. For example, the use of a consistent set of labor and craft code across industries and projects can provide for performance metrics and comparisons of specific “crafts” by a specific job description that provides consistency for these definitions.

For example a database of “crafts” by tasks, tools and technology, knowledge, skills, abilities, work activities, work context, job zone, education, interest, work style, work values, related occupation and additional information, can be associated with the exact craft. This allows for in-depth data details based on goals established during setup for any industry type employing workers of that craft. When data is entered into the system it can be synced to a cloud-based server application for access by any authorized computing device regardless of location or time. A centralized cloud-based database can provide data mining capabilities, and project study results according to uniform codes and sub-codes for industry specific internal, external, and best practices benchmarking that can be accessible from any device with networking capabilities.

An example embodiment includes the ability to store work performance information from a plurality of industries, and allow users to benchmark internal performance with any similar resource. Additionally, the system can provide information on worldwide standards, by type of business, assets, craft, or other criteria to establish performance benchmarks.

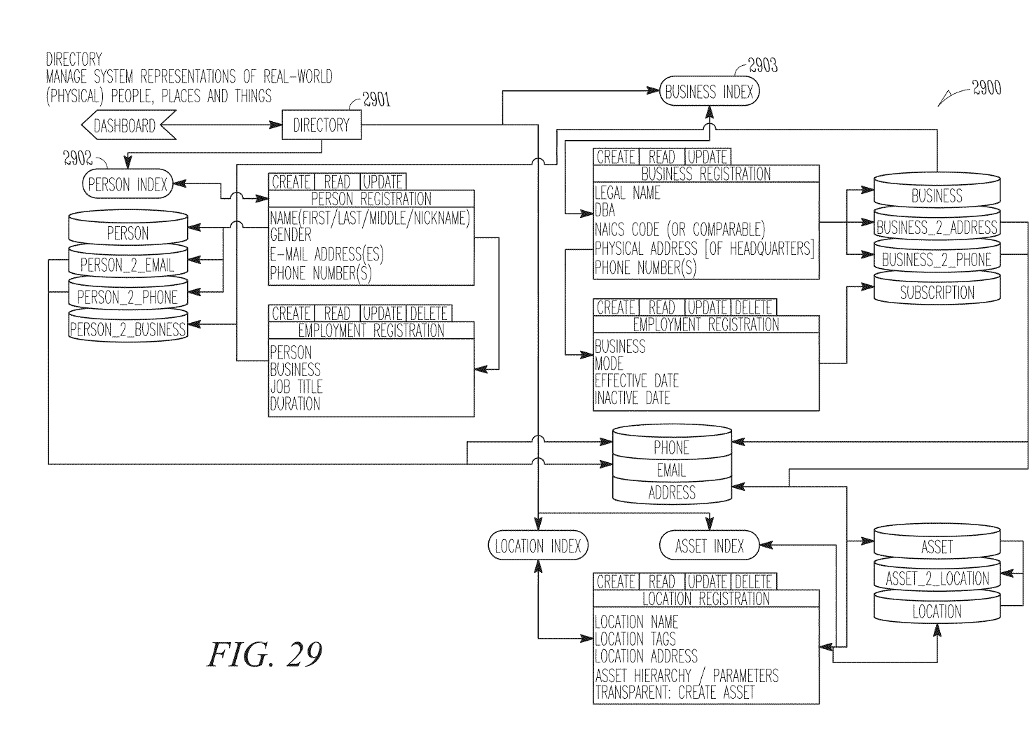

FIG. 29 depicts a block diagram 2900 illustrating an example directory module 2901 with a plurality of databases or data stores, according to an embodiment. The directory module may be accessed from the dashboard. The databases or data stores may each include one or more tables that contain data entries, which may be linked between tables or databases. For example, an individual person (e.g., a worker or foreman) may be registered in a person index 2902, and have an associated entry in a business index 2903.

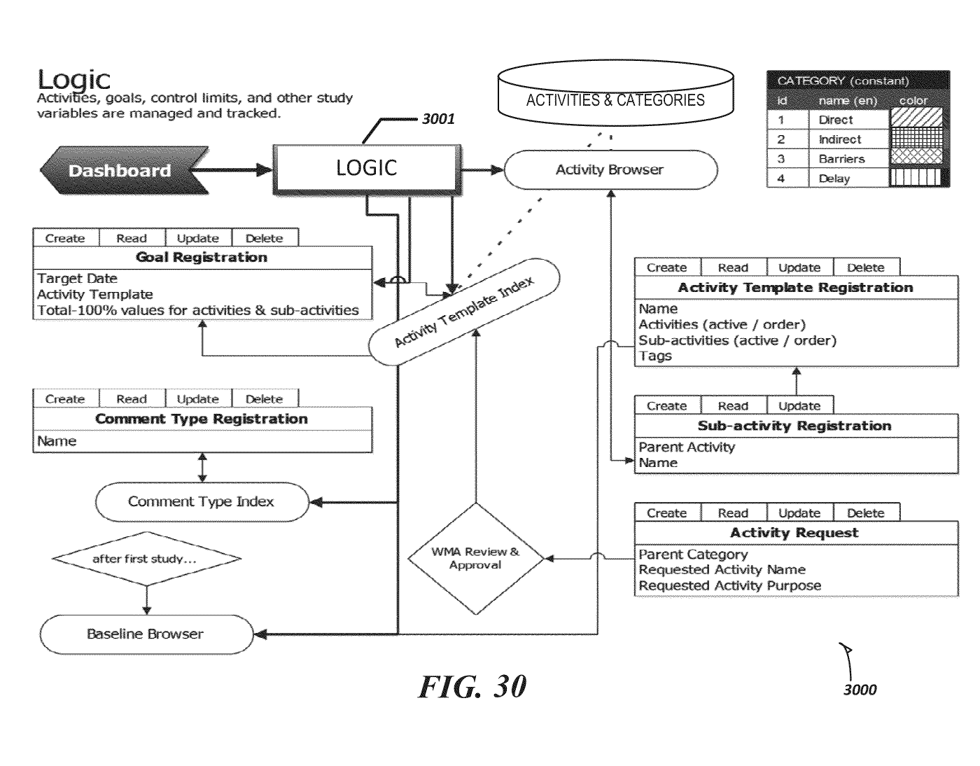

FIG. 30 depicts a block diagram 3000 illustrating an example logic module 3001, according to an embodiment. The logic module may be accessed from the dashboard, and may present an activity browser, a baseline browser, a comment type index, and an activity template index. The logic module may utilize an activities and categories database that include a plurality of tables containing activity and registration data.

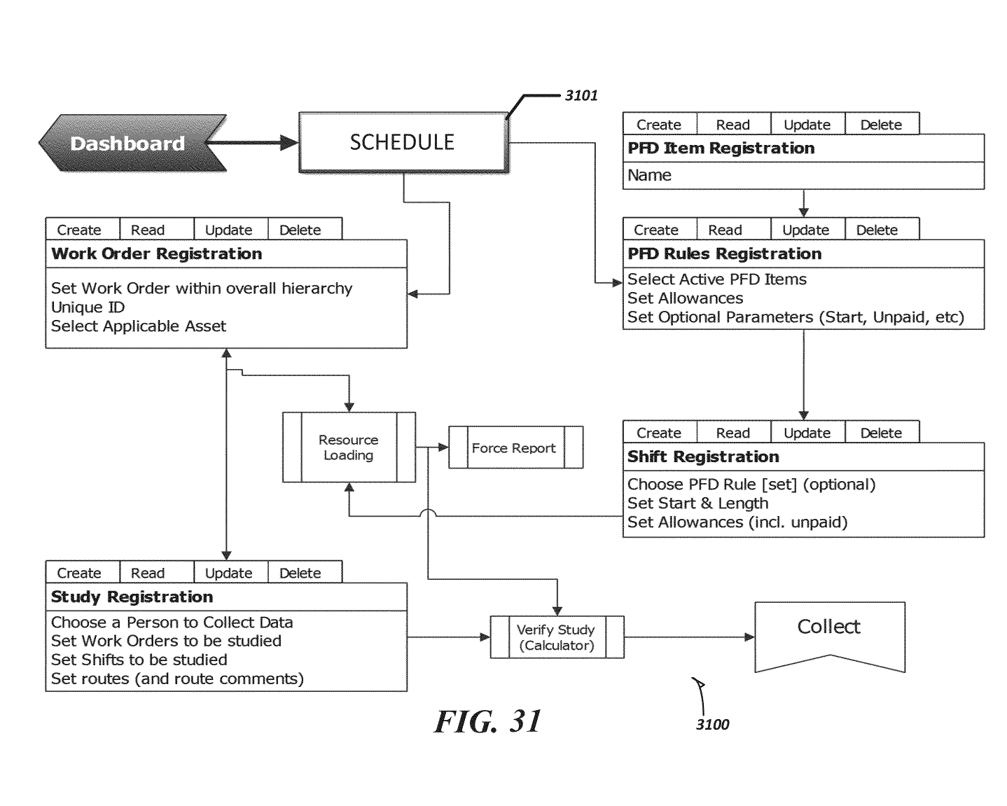

FIG. 31 depicts a block diagram 3100 illustrating an example schedule module 3101, according to an embodiment. The schedule module may be accessed from the dashboard, and may provide resource loading, force reports, and studying validity information. Data from the schedule module may be provided to a collection module.

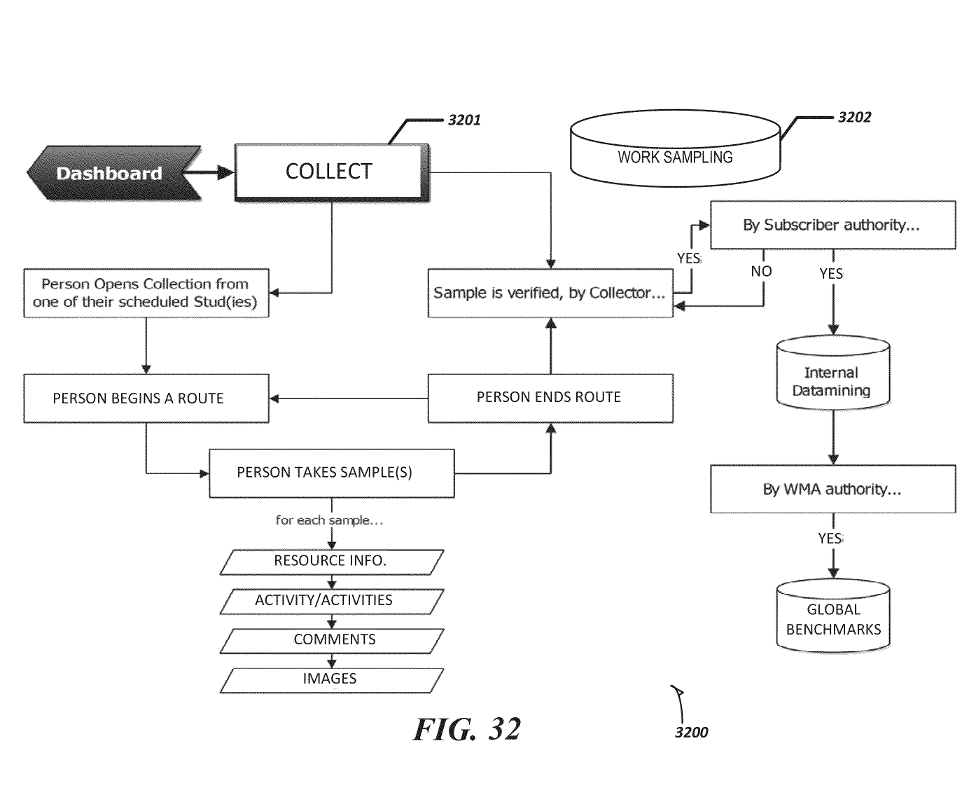

FIG. 32 depicts a block diagram illustrating an example collection module 3201, according to an embodiment. The collection module 3201 may be accessed from the dashboard, and may receive work sampling data 3203 in response to a user opening a set of collection data. The collection module 3201 may provide an interface to a person (e.g., a user or data collector) who is beginning a work sampling route. The collection module 3201 may prompt the person for resource information, worker activities or inactivity, and comments on the observed activities or environment. The collection module may also provide an interface to a camera or video recorder, and facilitate taking a photograph or video of an activity or environment of the worker at the location. The photograph or video, or both, may correspond to one or more activity records (e.g., work sampling data) maintained by the collection module 3201.

Upon completion of a route through a work location by the person, or during the entry of individual activity records, the collection module may attempt to verify any data samples. Additionally, the collection module may be configured to distinguish between identifiable data and non-identifiable data in a work sample. Identifiable data may be limited to use in an internal data mining database that is accessible only be a subscriber who commissioned or performed the work measurement project. Non-identifiable data may be added to a global benchmarks database that may include the industry performance information.

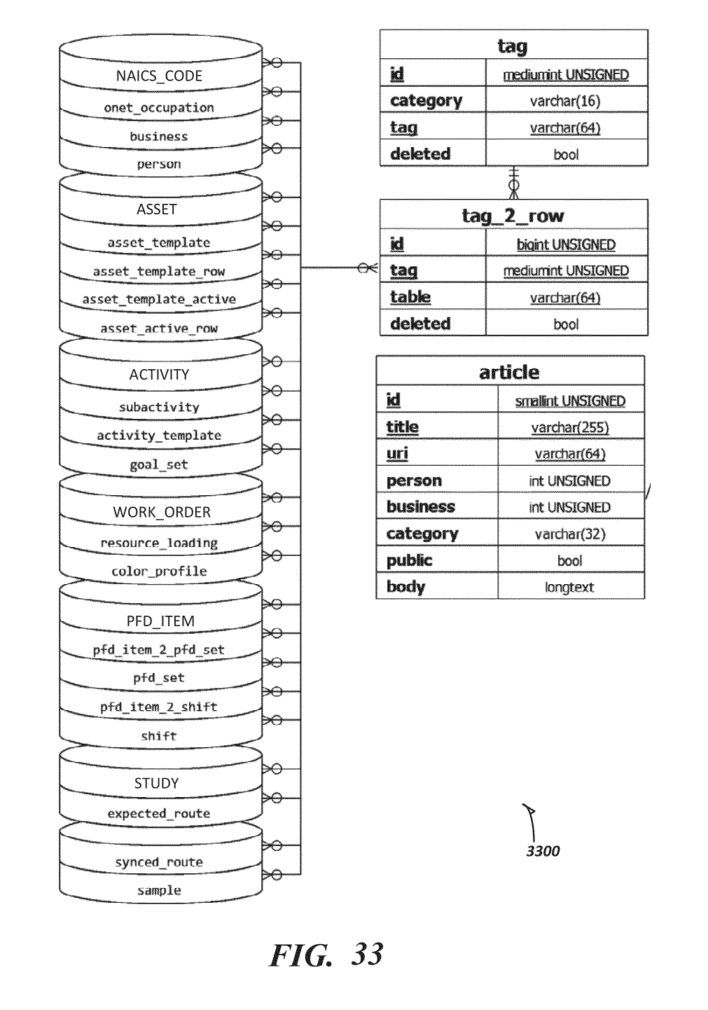

FIG. 33 depicts a block diagram illustrating an example of collection module databases 3300, according to an embodiment. The collection module databases 3300 may include, for example, NAICS codes, assets, activities, work orders, PFD items, study route data, or other collection information and details. The collection module databases 3300 may be coupled to a collection module for real-time access by a mobile data collection application.

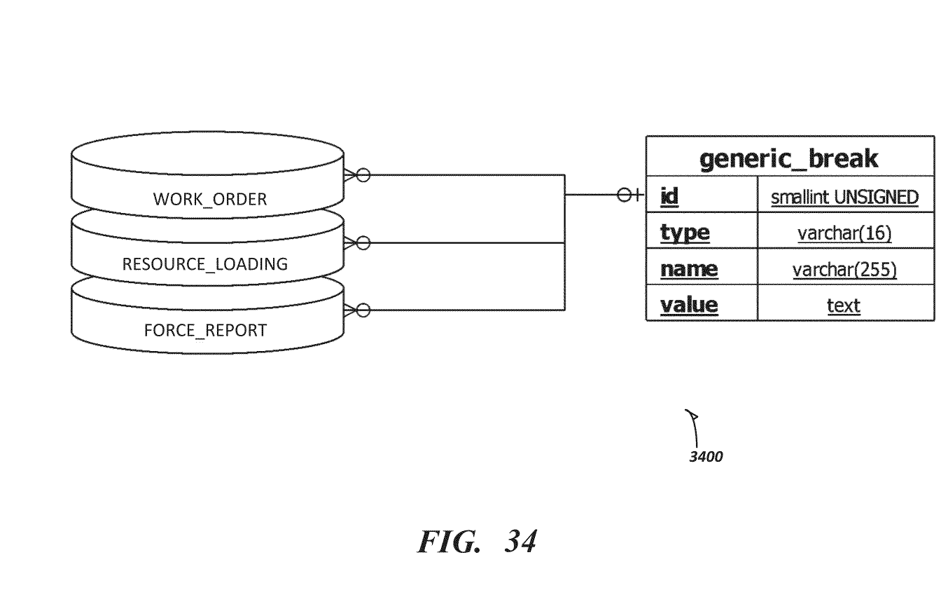

FIG. 34 depicts a block diagrams illustrating an example of work databases 3400, according to an embodiment. The work order databases 3400 may include work orders, resource loading information, and force report data.

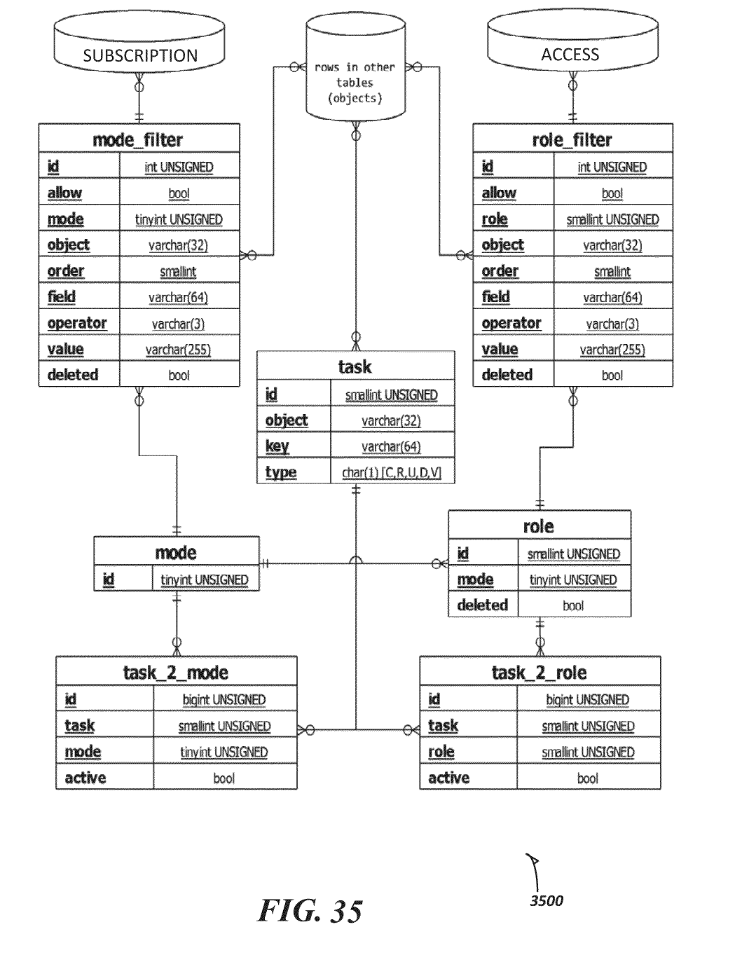

FIG. 35 depicts a block diagram illustrating an example of permissions databases 3500, according to an embodiment. The permissions databases 3500 may include subscription and access credentials that may be utilized to limit access to specific customer or location data. For example, multiple organizations that are operating in a single location may both desire the collection of work measurement data by a single work measurement organization, while maintaining segregated access to the performance data of each organization.

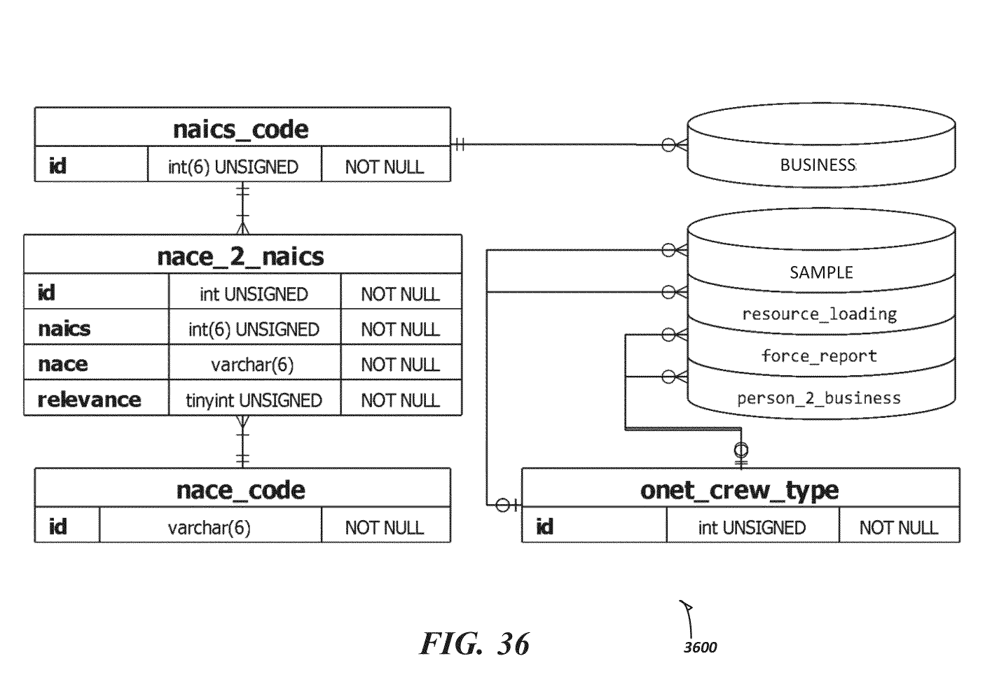

FIG. 36 depicts a block diagram illustrating an example directory database 3600, according to an embodiment.

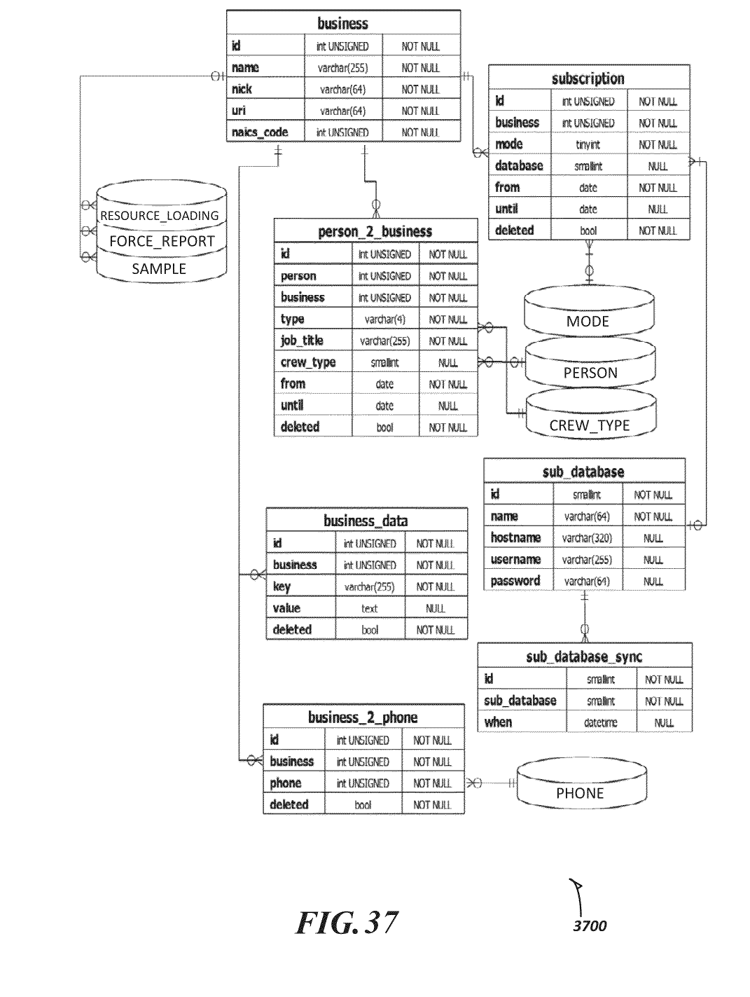

FIG. 37 depicts a block diagram illustrating an example of business databases 3700, according to an embodiment. The directory database 3700 may include resource loading, force report data, sample data, for one or more business entities.

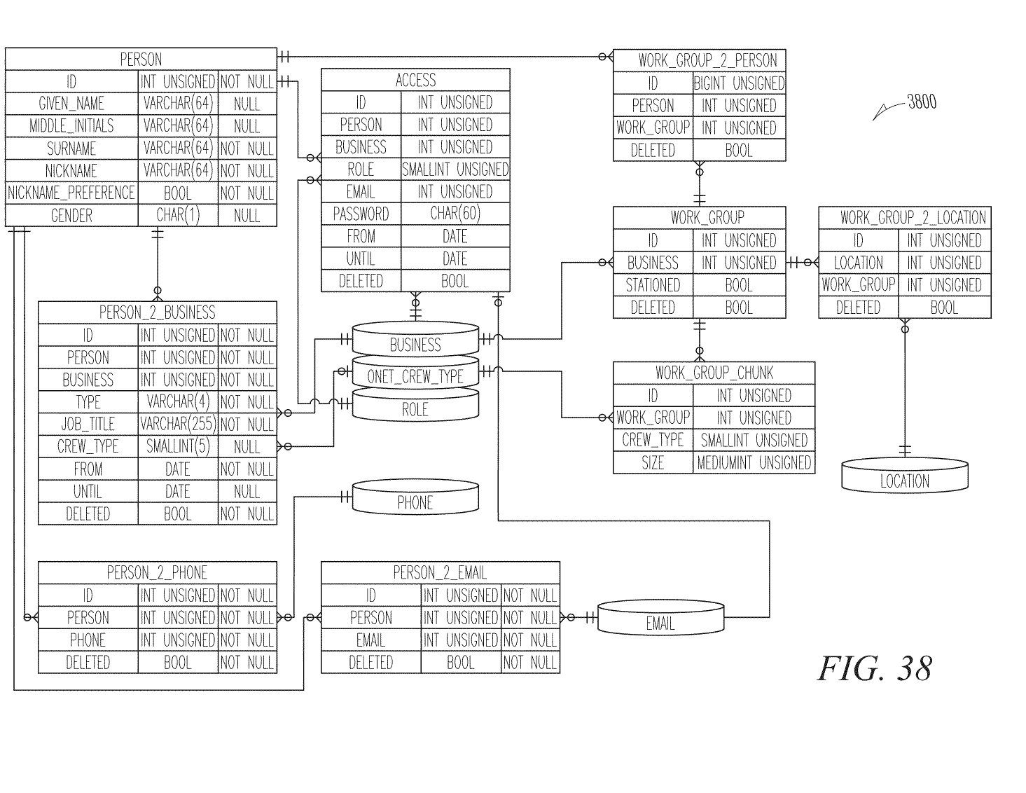

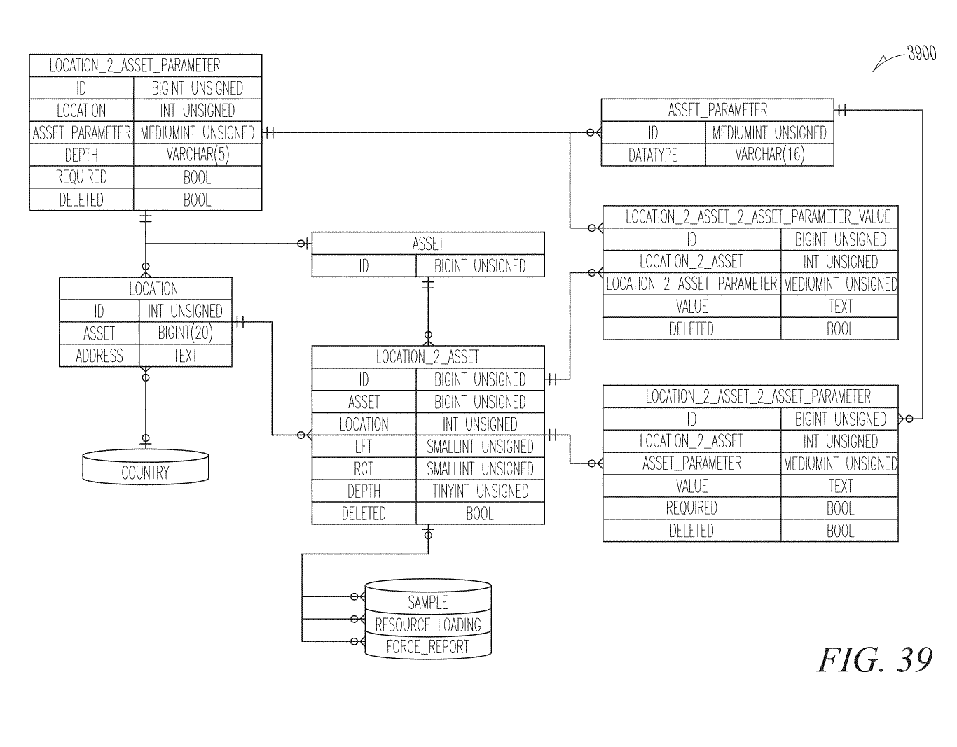

FIG. 38 depicts a block diagram illustrating an example of people databases 3800, according to an embodiment. The people databases 3800 may include business information, crew type data, roles, locations and contact information for multiple workers. FIG. 39 depicts a block diagram illustrating an example of location databases 3900, according to an embodiment.

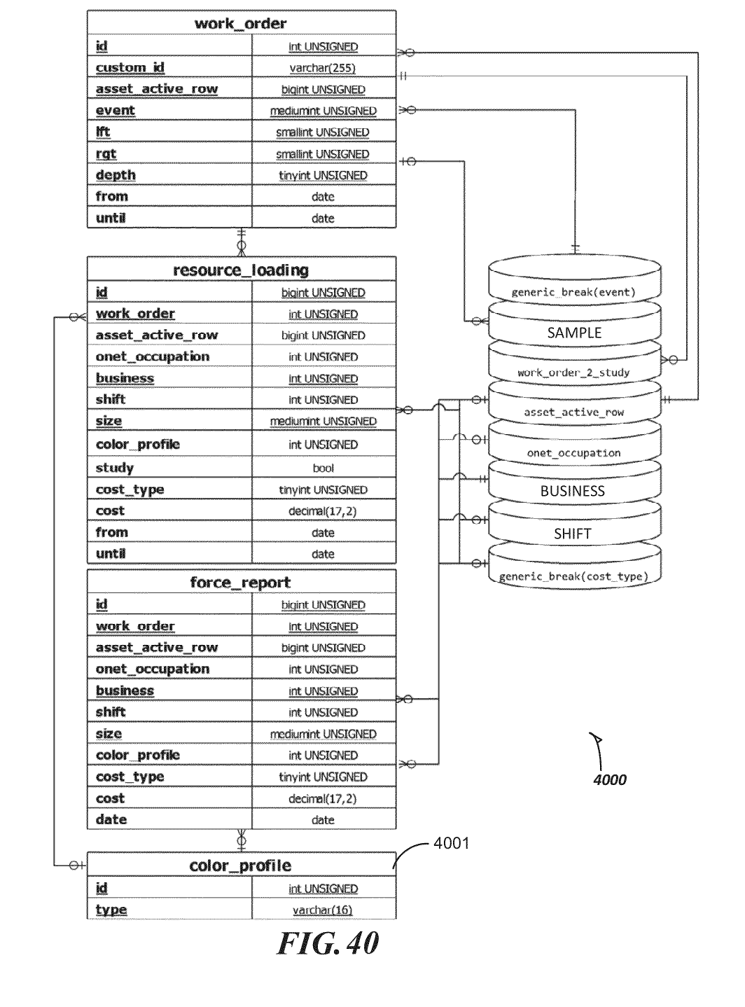

FIG. 40 depicts a block diagram illustrating an example of work order databases 4000, according to an embodiment. In an example, a color_profile table 4001 may include a mapping between expected worker uniforms and a worker craft or group. For example, a work order may indicate that a group of pipefitters and a group of electricians may be present during a shift, and the pipefitters may be identified by blue uniforms (e.g., hard hats) and the electricians may be identified by green uniforms. In a similar manner, RFID codes may be stored in an ID filed of the color_profile table 4001. The ID may correspond to a value stored in an RFID tag that is to be worn by a craft or group of one or more workers.

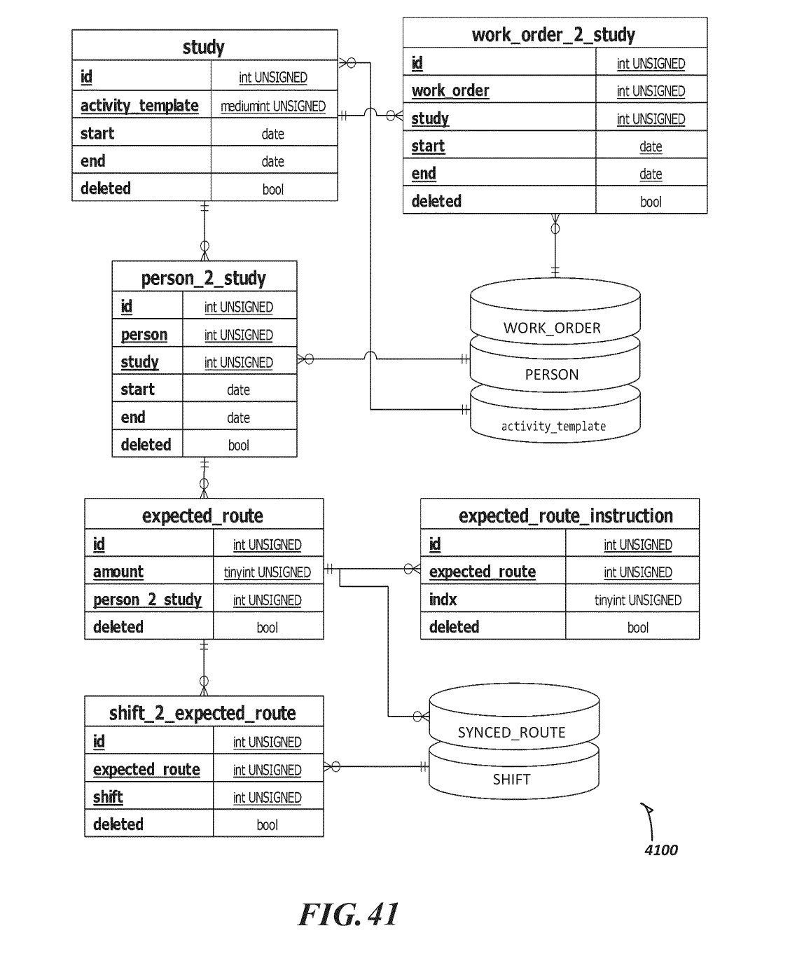

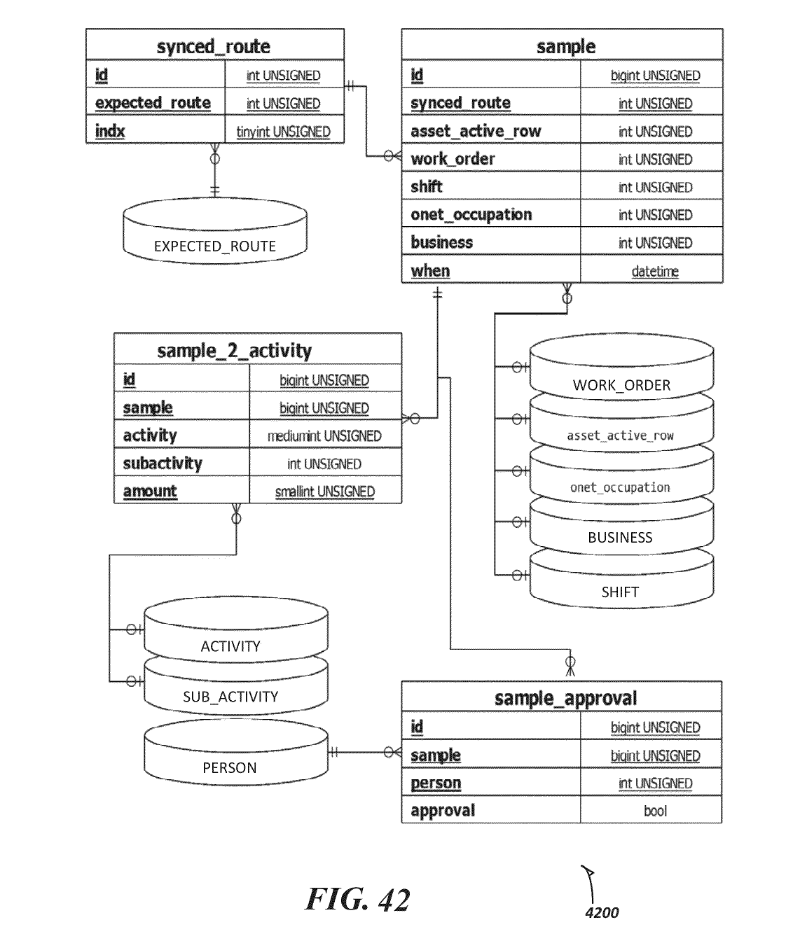

FIG. 41 depicts a block diagram illustrating an example of study databases 4100, according to an embodiment. FIG. 42 depicts a block diagram illustrating an example of work sampling databases 4200, according to an embodiment.

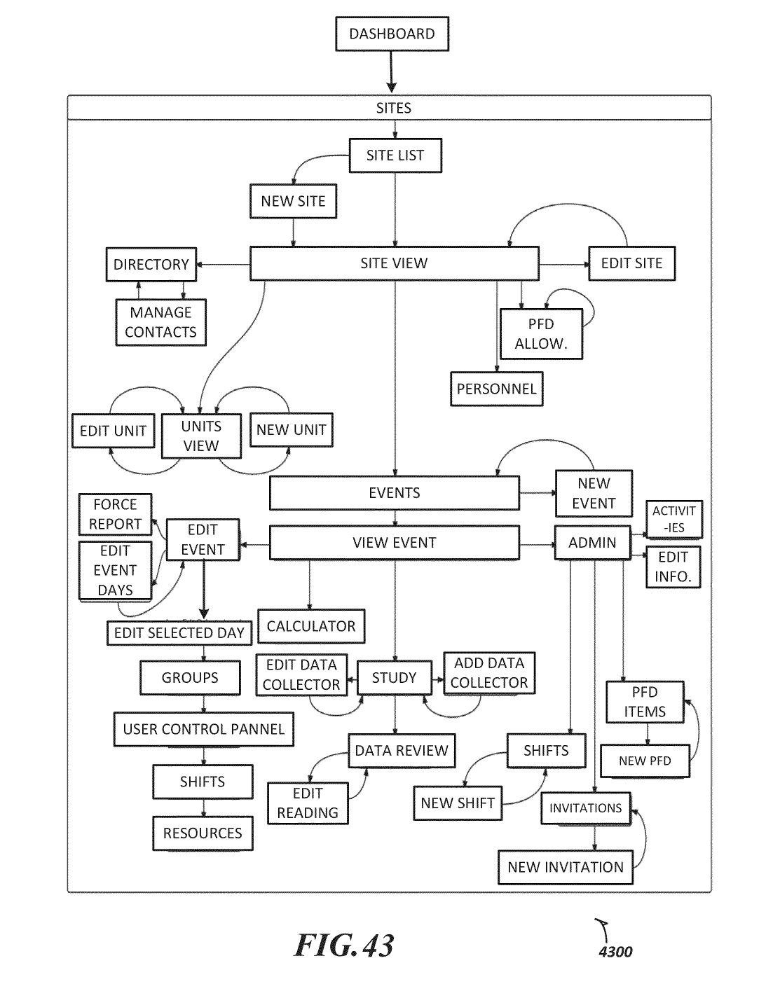

FIG. 43 depicts a block diagram illustrating an example of a user interface site hierarchy 4300 of a work sampling toolkit application, according to an embodiment. The work sampling toolkit application may be implemented on any of a variety of commercially available computing devices. For example, the user interface may include a login screen to provide individual user access and authentication, which may provide tracking of individual user activities and allow the association of collected data to individual data collectors. After login a user may be presented with a dashboard that includes modules for registration, a user control panel, user identification and contact information, union data, a help screen, and data collection interface for sites, events, or mobile computing applications. Each screen or interface may provide a user or data collector with a customizable area for data entry, data reporting, and additional comments for observed or unexpected activities during the a work sampling route.

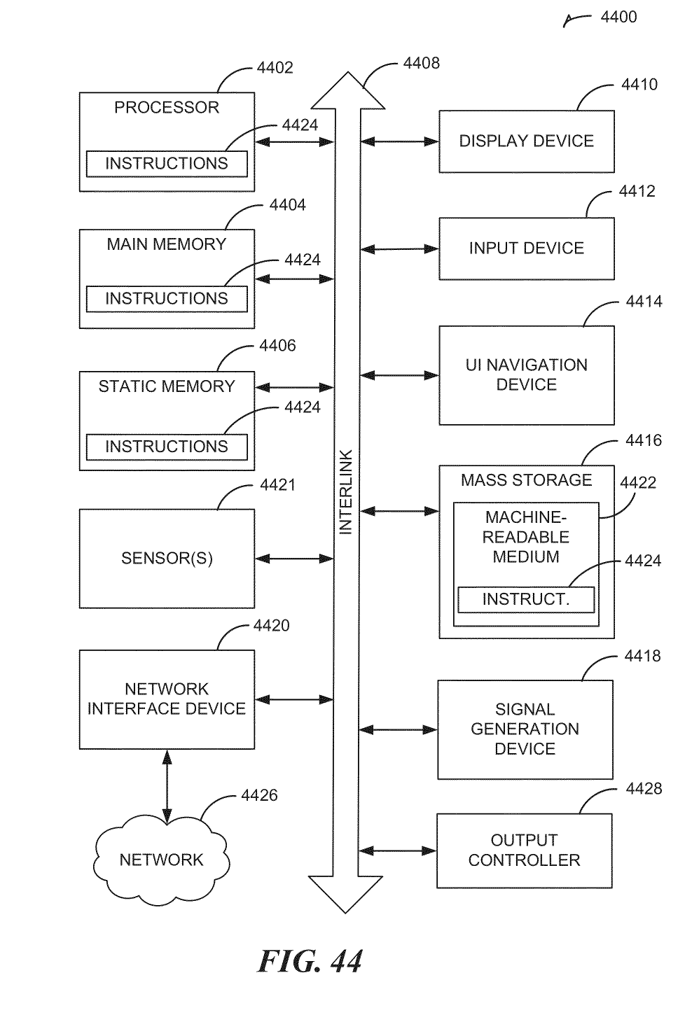

FIG. 44 illustrates a block diagram of an example machine 4400 upon which any one or more of the techniques (e.g., methodologies) discussed herein may be performed. In alternative embodiments, the machine 4400 may operate as a standalone device or may be connected (e.g., networked) to other machines. In a networked deployment, the machine 4400 may operate in the capacity of a server machine, a client machine, or both in server-client network environments. In an example, the machine 4400 may act as a peer machine in peer-to-peer (P2P) (or other distributed) network environment. The machine 4400 may be a personal computer (PC), a tablet PC, a Personal Digital Assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 4400 may include a hardware processor 4402 (e.g., a processing unit, a graphics processing unit (GPU), a hardware processor core, or any combination thereof), a main memory 4404, and a static memory 4406, some or all of which may communicate with each other via a link 4408 (e.g., a bus, link, interconnect, or the like). The machine 4400 may further include a display device 4410, an input device 4412 (e.g., a keyboard), and a user interface (UI) navigation device 4414 (e.g., a mouse). In an example, the display device 4410, input device 4412, and UI navigation device 4414 may be a touch screen display. The machine 4400 may additionally include a mass storage (e.g., drive unit) 4416, a signal generation device 4418 (e.g., a speaker), a network interface device 4420, and one or more sensors 4421, such as a global positioning system (GPS) sensor, camera, video recorder, compass, accelerometer, or other sensor. The machine 4400 may include an output controller 4428, such as a serial (e.g., universal serial bus (USB), parallel, or other wired or wireless (e.g., infrared(IR)) connection to communicate or control one or more peripheral devices (e.g., a printer, card reader, etc.).

The mass storage 4416 may include a machine-readable medium 4422 on which is stored one or more sets of data structures or instructions 4424 (e.g., software) embodying or utilized by any one or more of the techniques or functions described herein. The instructions 4424 may also reside, completely or at least partially, within the main memory 4404, within static memory 4406, or within the hardware processor 4402 during execution thereof by the machine 4400. In an example, one or any combination of the hardware processor 4402, the main memory 4404, the static memory 4406, or the mass storage 4416 may constitute machine readable media.

While the machine-readable medium 4422 is illustrated as a single medium, the term “machine readable medium” may include a single medium or multiple media (e.g., a centralized or distributed database, and/or associated caches and servers) that configured to store the one or more instructions 4424.

The term “machine-readable medium” may include any tangible medium that is capable of storing, encoding, or carrying instructions for execution by the machine 4400 and that cause the machine 4400 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 4424 may further be transmitted or received over a communications network 4426 using a transmission medium via the network interface device 4420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), peer-to-peer (P2P) networks, among others. In an example, the network interface device 4420 may include one or more physical jacks (e.g., Ethernet, coaxial, or phone jacks) or one or more antennas to connect to the communications network 4426. In an example, the network interface device 4420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 4400, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of measuring worker performance, the method comprising:
receiving a performance collection project at a handheld electronic device, the performance collection project including: location data, a plurality of worker crafts, a plurality of worker activities, and a collection route;
receiving, at the handheld electronic device, a plurality of activity readings for one or more workers based at least in part on the performance collection project, each one of the plurality of activity readings including: a location of the one or more workers from the location data, a craft of the one or more workers from the plurality of worker crafts, and an activity of the one or more workers from the plurality of worker activities;
receiving an asset record, at the handheld electronic device, the asset record including an asset corresponding to the one or more workers along the collection route; and
transmitting the plurality of activity readings and the asset record from the handheld electronic device to a server communicatively coupled to the handheld electronic device.

2. The method of claim 1, further comprising:
displaying a data collection instruction via the handheld electronic device, the instruction including a number of activity records needed along the collection route to achieve a desired confidence level for the performance collection project.

3. The method of claim 2, further comprising:
generating the performance collection project based on an analysis of the location data, the plurality of worker crafts, and the plurality of worker activities, and a list of specific types of assets.

4. The method of claim 1, wherein the plurality of worker readings include: an standardized industry type, a standardized sub-industry type, a craft type, a job type, an event type, a list of assets, a shift time, and a list of personal fatigue and delay allowances.

5. The method of claim 4, further comprising:
receiving an activity reading where a worker is idle; wherein the activity reading includes a reason the worker is idle.

6. The method of claim 5, wherein the reason the worker is idle includes an indication that an asset is unavailable.

7. The method of claim 2, wherein the handheld electronic device includes a camera or video recorder; and receiving an activity reading includes capturing a photograph or video of an activity or environment of the worker at the location.

8. The method of claim 2, wherein recording a plurality of activity readings includes categorizing an activity reading as one of a plurality of work performance categories.

9. The method of claim 8, wherein the work performance categories comprise: direct work, indirect work, barriers, and delay.

10. The method of claim 1, further comprising:
performing an analysis of the plurality of activity readings of one or more workers; and
generating a report, based at least in part on a result of the analysis of the plurality of activity readings of one or more workers, the report including a work improvement candidate comprising: a location, a worker type, and a worker activity.

11. The method of claim 10, further comprising:
performing a comparison of the result of the analysis with an industry benchmark,
the industry benchmark including historical performance related to the location data, the plurality of worker types, and the plurality of worker activities.

12. A work measurement system comprising:
a project selection module coupled to a project database, the project database including: craft data, contractor data, location data and asset data, the project selection module being configured to automatically generate a data collection template based on a selection of one or more worker activities, a contractor, a location, and a plurality of assets, and populate the project database with the data collection template;
a collection module coupled to the project database, the collection module being configured to populate the project database with a plurality of activity observations including the one or more worker activities, the contractor, the location, and an asset of the plurality of assets; and
an analysis module coupled to an industry performance database and the project database, the analysis module being configured to generate a report based on a comparison of the plurality of activity observations in the project database with historical performance data in the industry performance database related to the one or more worker activities, the contractor, the location, and an asset of the plurality of assets.

13. The system of claim 12, further comprising: an import module configured to import data from a third-party, the data including: asset records, worker data, industry benchmarks, or regulatory codes.

14. The system of claim 12, further comprising: a user interface presented on a display of the mobile data collection device, the user interface configured to present a plurality of industry and labor classification codes in the data collection template, receive input corresponding to the activity observation, and provide the collection module with the activity observation including selected industry or labor classification codes.

15. The system of claim 14, wherein the collection module includes a decision matrix configured to provide data collection options to the user in the data collection template.

16. The system of claim 14, further comprising:
a notification module configured to provide feedback in response to the entry of the plurality of activity observations; wherein the feedback may be provided to the user via the user interface and to an observation manager via a transmitted notification.

17. The system of claim 12, wherein the collection module is configured to distinguish between identifiable data and non-identifiable data in the data collection template and the plurality of activity observations; wherein the non-identifiable data is added to the industry performance database by the analysis module.

18. The system of claim 12, further comprising: a mobile data collection device including a sensor, the sensor being configured to receive sensor data from a tag associated with a worker, a location or an asset;
wherein the sensor data is combined with a corresponding one of the plurality of activity observations in the project database.

19. The system of claim 18, wherein mobile data collection device includes a camera or video recorder; and the collection module is configured to attach a photograph or video of an activity or environment to an activity observation.

20. A tangible computer-readable medium including instructions that can cause a computing device to:
receive a performance collection project including a location, an event, and an activity to be performed by one or more workers;
generate a performance data-collection template in response to receiving the performance collection project, the template including a sequence of work measurement instructions based on the performance collection project;
validate a desired confidence level for the performance collection project;
present the sequence of work measurement instructions via a user interface of the computing device, the work measurement instructions including a route through the location;
receive an activity reading via the user interface, the activity reading including: an asset, and an activity at the location being performed by the one or more workers; and
transmit the activity reading through a communication link to a server.

21. The tangible computer-readable medium of claim 20, further comprising instructions to cause the computing device to:
receive a plurality of activity readings representing actions of a plurality of the one or more workers;
receive an asset record indicating an asset needed by at least one of the plurality of workers; and
generate a report from an analysis of the plurality of activity readings and the asset record, the report including an indication of a status of the asset that caused an actual reduction in performance of one or more of the plurality of workers.

22. The tangible computer-readable medium of claim 20, wherein the generation of the performance data-collection template comprises:
accessing a database containing a plurality of crafts;
retrieving a subset of the plurality of crafts and storing the subset in a project database;
accessing a database containing a plurality of assets for a site; and
retrieving and storing a subset of the plurality of assets for the site in the project database, wherein the assets are related to the subset of the plurality of crafts;
wherein the user interface is configured to selectively present the subset of the plurality of crafts and the subset of the plurality of assets when the site is selected by the user.

23. The tangible computer-readable medium of claim 22, further comprising instructions to cause the computing device to:
retrieve a subset of the plurality of work rules from a database containing a plurality of work rules; and
store the subset in the project database, wherein the subset of the plurality of work rules are related to the subset of the plurality of crafts.

24. The tangible computer-readable medium of claim 20, further comprising instructions to cause the computing device to:
predict human biases that may impact the performance collection project;
wherein generation of the performance data-collection template includes ordering the sequence of work measurement instructions to decrease an effect of the human biases on the performance collection project.

25. The tangible computer-readable medium of claim 20, further comprising instructions to cause the computing device to:
provide feedback in response to the entry of the activity reading; wherein the feedback may be provided to the user via the user interface and to an observation manager via a transmitted notification.
